(19) United States
(12) Patent Application Publication
(10) Pub. No.: US 2012/0055730 A1
(43) Pub. Date: Mar. 8, 2012

(54) Steering control apparatus

(75) Inventors: Yasuhiko Mukai, Anjo-city (JP); Hideki Kabune, Nagoya-city (JP); Kouichi Nakamura, Toyota-city (JP); Masashi Hori, Anjo-city (JP)

(73) Assignees: Nippon Soken, Inc., Nishio-city (JP); DENSO CORPORATION, Kariya-city (JP)

(21) Appl. No.: 13/136,763

(22) Filed: Aug. 10, 2011

(30) Foreign Application Priority Data
Aug. 19, 2010 (JP) 2010-183952

(51) Int. Cl. B62D 6/08; B62D 5/04

(52) U.S. Cl. 180/444; 180/446

(57) ABSTRACT

A steering control apparatus has a variable gear ratio device and a power steering device. If abnormality arises in the VGRS device, an EPS motor is controlled based on a steering wheel angle and a speed increase ratio. Thus, vehicle wheels are controlled appropriately when abnormality arises in the VGRS device. Steered angle of the vehicle wheels relative to the steering wheel angle is not changed between before and after occurrence of abnormality in the VGRS device. As a result, movement of a vehicle does not deviate from the steering wheel angle and feeling of discomfort in steering a vehicle can be reduced.

### CROSS REFERENCE TO RELATED APPLICATION

This application is based on and incorporates herein by reference Japanese patent application No. 2010-183952 filed on Aug. 19, 2010.

### FIELD OF THE INVENTION

The present invention relates to a steering control apparatus, which includes a variable gear ratio device and a power steering device and performs variable gear ratio function by the power steering device when the variable gear ratio device has abnormality.

### BACKGROUND OF THE INVENTION

A conventional variable gear ratio steering (VGRS) apparatus varies steered angle of steered wheels (vehicle wheels) of a vehicle relative to steering wheel angle of a steering wheel (for example, refer to patent documents 1 to 3). The VGRS apparatus according to patent document 1 is provided with a differential gear mechanism and a gear ratio control motor, which drives the differential gear mechanism. In recent years, an electric power steering (EPS) apparatus, which electrically generates torque as an apparatus for power-assisting steering operation of a vehicle, is used together with the VGRS apparatus.
(Patent document 1) JP 2008-273327A (US 2008/0264714 A1)
(Patent document 2) JP 2005-162124A (JP 4228899)
(Patent document 3) JP 2009-126421A

In case that abnormality arises in the VGRS apparatus, for example, the gear ratio control motor is locked by a lock mechanism or the gear ratio control motor is controlled to generate holding torque for fixing the gear ratio. Thus, the gear ratio is fixed and idling of the steering wheel is suppressed. However, if the gear ratio is fixed in case of abnormality of the VGRS apparatus, the steered angle of the steered wheels relative to the steering wheel angle of the steering wheel between before and after occurrence of abnormality of the VGRS apparatus. This causes a driver to feel uneasiness or discomfort.

### SUMMARY OF THE INVENTION

It is an object of the present invention to provide a steering control apparatus, which appropriately controls a steered angle of vehicle wheels in case of occurrence of abnormality of a VGRS apparatus.

According to the present invention, a steering control apparatus comprises an input shaft coupled to a steering device operated by a driver of a vehicle, an output shaft provided rotatably to the input shaft and forming a torque transfer path to transfer torque applied to the steering device to vehicle wheels, a variable gear ratio device including a gear mechanism, which transfers rotation of the input shaft to the output shaft, and a first motor, which drives the gear mechanism, the variable gear ratio device varying a ratio between a steering wheel angle of the steering device and a rotation angle of the output shaft, and a power steering device including a second motor for power-assisting driver's steering operation of the steering device by torque generated by driving the second motor. The steering control apparatus includes a first drive control part and a second drive control part. The first drive control part controls drive of the first motor based on a steering wheel angle and a speed increase ratio. The second drive control part controls drive of the second motor based on the steering wheel angle and the speed increase ratio, when abnormality is detected in the variable gear ratio device.

### BRIEF DESCRIPTION OF THE DRAWINGS

The foregoing and other objects, features and advantages of the present invention will become more apparent from the following detailed description made with reference to the accompanying drawings. In the drawings:

FIG. 1 is a schematic view showing a steering control apparatus according to a first embodiment of the present invention;

FIG. 2 is a sectional view of the steering control apparatus according to the first embodiment;

FIG. 3 is a sectional view of the steering control apparatus taken along a line in FIG. 2;

FIG. 4 is a side view of a worm gear provided in the steering control apparatus according to the first embodiment;

FIG. 5 is a side view of the worm gear viewed in a direction V in FIG. 4;

FIG. 6 is a side view of the worm gear viewed in a direction VI in FIG. 4;

FIG. 7 is a sectional view of the worm gear taken along a line in FIG. 4;

FIG. 8 is a block diagram showing a VGRS ECU provided in the steering control apparatus according to the first embodiment;

FIG. 9 is a block diagram showing an EPS ECU provided in the steering control apparatus according to the first embodiment;

FIG. 10 is a flowchart showing control calculation processing executed by the VGRS ECU in the first embodiment;

FIG. 11 is a flowchart showing VGRS motor rotation angle command value calculation processing executed in the first embodiment;

FIG. 12 is a flowchart showing VGRS motor rotation angle control calculation processing executed in the first embodiment;

FIG. 13 is a flowchart showing PWM command value calculation processing executed in the first embodiment;

FIG. 14 is a graph showing a relation between a travel speed and a speed increase ratio in the first embodiment;

FIG. 15 is a flowchart showing control calculation processing executed normally by an EPS ECU in the first embodiment;

FIG. 16 is a flowchart showing EPS motor current command value calculation processing executed normally in the first embodiment;

FIG. 17 is a flowchart showing EPS motor current control calculation processing executed normally in the first embodiment;

FIG. 18 is a flowchart showing EPS motor PWM command value calculation processing executed normally in the first embodiment of the present invention;

FIG. 19 is a graph showing a relation among steering torque, travel speed and an EPS motor current command value in the first embodiment;

FIG. 20 is a flowchart showing VGRS apparatus abnormality check processing executed in the first embodiment;

FIG. 21 is a flowchart showing control calculation processing executed by the EPS ECU in case of abnormality in the VGRS apparatus in the first embodiment;

FIG. 22 is a flowchart showing EPS motor rotation angle command value calculation processing executed in case of abnormality in the VGRS apparatus in the first embodiment;

FIG. 23 is a flowchart showing EPS motor rotation angle control calculation processing executed in case of abnormality in the VGRS apparatus in the first embodiment;

FIG. 24 is a flowchart showing EPS motor PWM command value calculation processing executed in case of abnormality in the VGRS apparatus in the first embodiment;

FIG. 25 is a flowchart showing self-lock failure detection processing (1) executed in the first embodiment;

FIG. 26 is a flowchart showing self-lock failure detection processing (2) executed in the first embodiment;

FIG. 27 is a flowchart showing self-lock failure detection processing (3) executed in the first embodiment;

FIG. 28 is a flowchart showing self-lock failure detection processing (4) executed in the first embodiment;

FIG. 29 is a flowchart showing self-lock failure detection processing (5) executed in the first embodiment;

FIG. 30 is a schematic view showing a steering control apparatus according to a second embodiment of the present invention;

FIG. 31 is a side view of a worm gear provided in the steering control apparatus according to a third embodiment;

FIG. 32 is a side view of the worm gear viewed in a direction R in FIG. 31;

FIG. 33 is a side view of the worm gear viewed in a direction S in FIG. 31, and

FIG. 34 is a sectional view of the worm gear taken along a line TT in FIG. 31.

### DETAILED DESCRIPTION OF THE EMBODIMENT

### First Embodiment

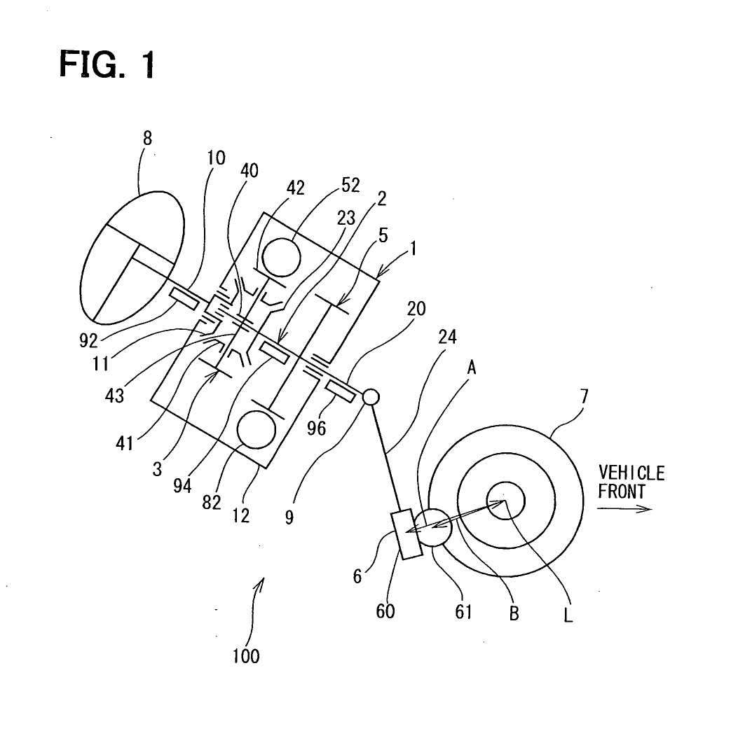

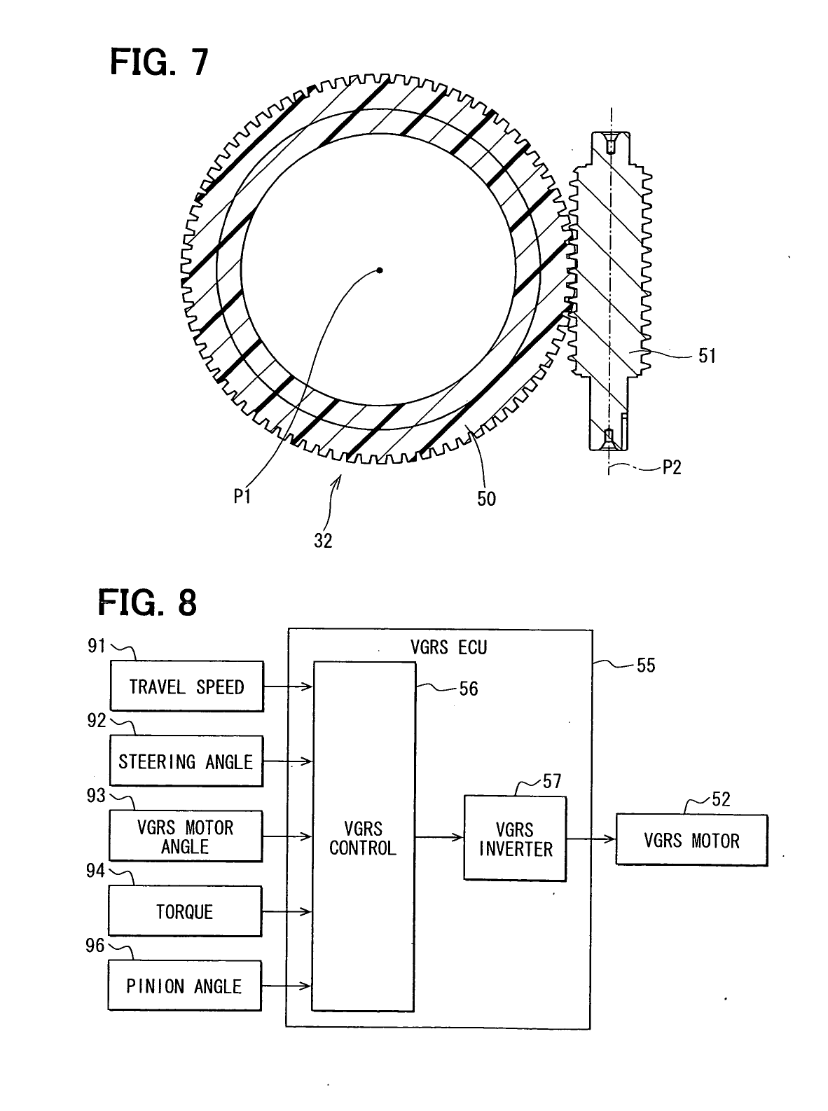

A steering control apparatus according to a first embodiment of the present invention will be described with reference to FIG. 1 to FIG. 29. General structure of a steering system 100 will be described first with reference to FIG. 1.

As shown in FIG. 1, the steering system 100 includes a steering control apparatus 1, a column shaft 2, a rack-and-pinion mechanism 6, vehicle wheels (steered front vehicle tire wheels) 7, a steering wheel 8 as a steering device, and the like. The column shaft 2 and the rack-and-pinion mechanism 6 form a torque transfer path.

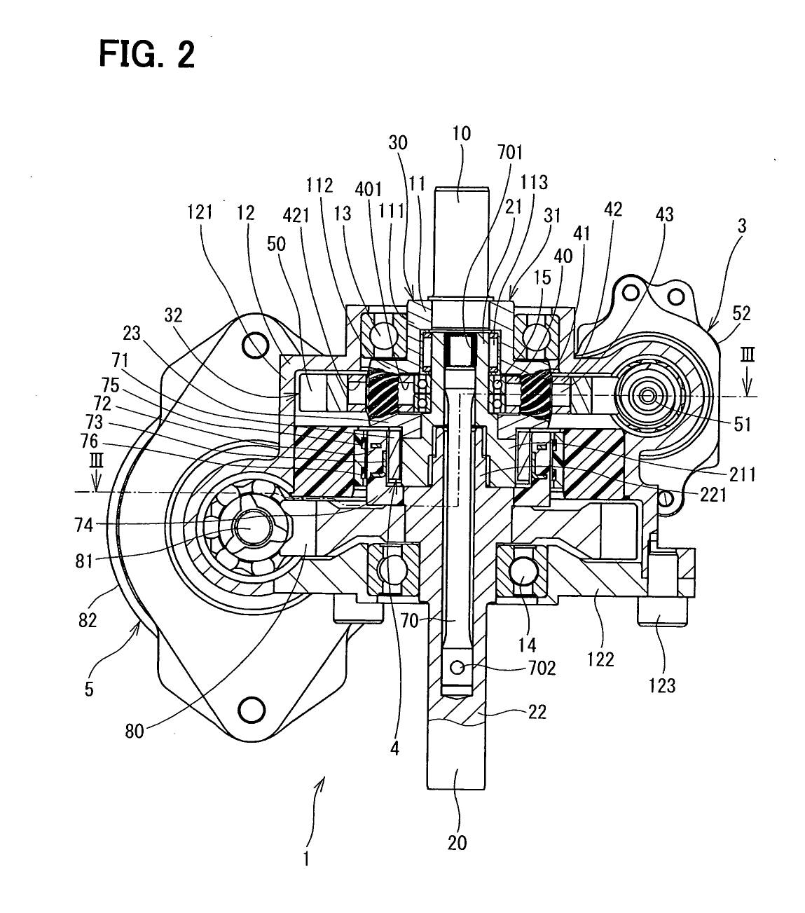

The steering control apparatus 1 includes a variable gear ratio steering device 3, an electric power steering device 5 and the like. The variable gear ratio steering device 3 varies a ratio between a rotation angle of an input shaft 10 and a rotation angle of an output shaft 20. The electric power steering device 5 is a power steering device, which generates assist torque for assisting steering operation of the steering wheel 8 by a driver. The variable gear ratio steering device 3 and the electric power steering device 5 are referred to as a VGRS device and an EPS device, respectively. The VGRS device 3 and the EPS device 5 are provided about the column shaft 2 and accommodated within a housing 12. The VGRS device 3 and the EPS device 5 are thus integrated into a single module. The steering control apparatus 1 will be described in detail later with reference to FIG. 2 and so on.

In the steering control apparatus 1, the column shaft 2 includes the input shaft 10, the output shaft 20. The output shaft 20 is coupled to a universal joint 9 and a shaft 24. The input shaft 10 is coupled to the steering wheel 8, which is steered by a driver. A steering wheel angle sensor 92 is provided on the input shaft 10 to detect a steering wheel angle, which indicates an angle of steering of the steering wheel 8. Since the steering wheel 8 and the input shaft 10 are coupled to each other, the steering wheel angle of the steering wheel 8 equals the rotation angle of the input shaft 10. The steering wheel angle of the steering wheel 8 is referred to as a steering wheel angle θh.

The output shaft 20 is provided coaxially with the input shaft 10 and relatively rotatable to the input shaft 10. The input shaft 10 and the output shaft 20 are rotated in opposite directions due to operation of a differential gear 31 of the VGRS device 3. The output shaft 20 transfers steering torque, which is generated by steering operation of the steering wheel 8 by the driver, to the vehicle wheels 7 through the universal joint 9, the shaft 24 and the rack-and-pinion mechanism 6. A pinion angle sensor 96 is provided on the output shaft 20 to detect a pinion angle. The torque generated by steering operation of the steering wheel 8 is referred to as steering torque Tq. The rotation angle of the output shaft 20 is referred to as a pinion angle θp.

The rack-and-pinion mechanism 6 includes a steering pinion 60, a steering rack bar 61 and the like. The rack-and-pinion mechanism 6 is positioned at a rear side of a vehicle relative to a straight line (indicated by L in FIG. 1), which connects centers of rotation of the vehicle wheels 7, which are provided at a left side and a right side of the vehicle. The steering pinion 60 is a disk-shaped gear and provided at an axial end, which is opposite to the steering wheel 8. The steering pinion 60 is rotatable in both forward and reverse directions with the shaft 24. A steering rack bar 61 is provided movably in both left and right directions of the vehicle. As rack teeth provided on the steering rack bar 61 are meshed with the steering pinion 60, rotary motion of the steering pinion 60 is changed into linear motion of the steering rack bar 61 in left and right directions of the vehicle. That is, the rack-and-pinion mechanism 6 changes the rotary motion of the column shaft 2 to the linear motion.

Although not shown, tie rods and knuckle arms are provided at both ends of the steering rack bar 61 so that the steering rack bar 61 is coupled to the vehicle wheels 7 through the tie rods and the knuckle arms. Thus the vehicle wheels 7 at left and right sides are steered in correspondence to an amount of movement of the steering rack bar 61.

A distance between the steering pinion 60 and the straight line L connecting the centers of rotation of the vehicle wheels 7 is longer than a distance B between the steering rack bar 61 and the line L connecting the centers of rotation of the vehicle wheels 7. The output shaft 20 rotates in a direction opposite to that of the input shaft 10 because of operation of the differential gear 31 provided between the input shaft 10 and the output shaft 20. For this reason, when the steering wheel 8 is steered in the counter-clockwise direction (left direction), the steering pinion 60 rotates in the clockwise direction when viewed from the side of the universal joint 9. The steering rack bar 61 moves in the right direction and the steered angle of the vehicle wheels 7 is varied so that the vehicle turns in the left direction. When the steering wheel 8 is steered in the clockwise direction (right direction), the steering pinion 60 rotates in the counter-clockwise direction when viewed from the side of the universal joint 9. The steering rack bar 61 moves in the left direction and the steered angle of the vehicle wheels 7 is varied so that the vehicle turns in the right direction.

By thus setting the distance A between the steering pinion 60 and the straight line L connecting the centers of rotation of the vehicle wheels 7 to be longer than the distance B between the steering rack bar 61 and the straight line L connecting the centers of rotation of the vehicle wheels 7, that is, A>B, the vehicle wheels 7 are steered in the direction opposite to the direction of rotation of the output shaft 20, the shaft 24 and the steering pinion 60. The direction of rotation of the steering wheel 8 and the direction of steered angle of the vehicle wheels 7 are matched. Thus, it is not necessary to provide a gear device and the like, which reverses the direction of rotation of the output shaft 20 again.

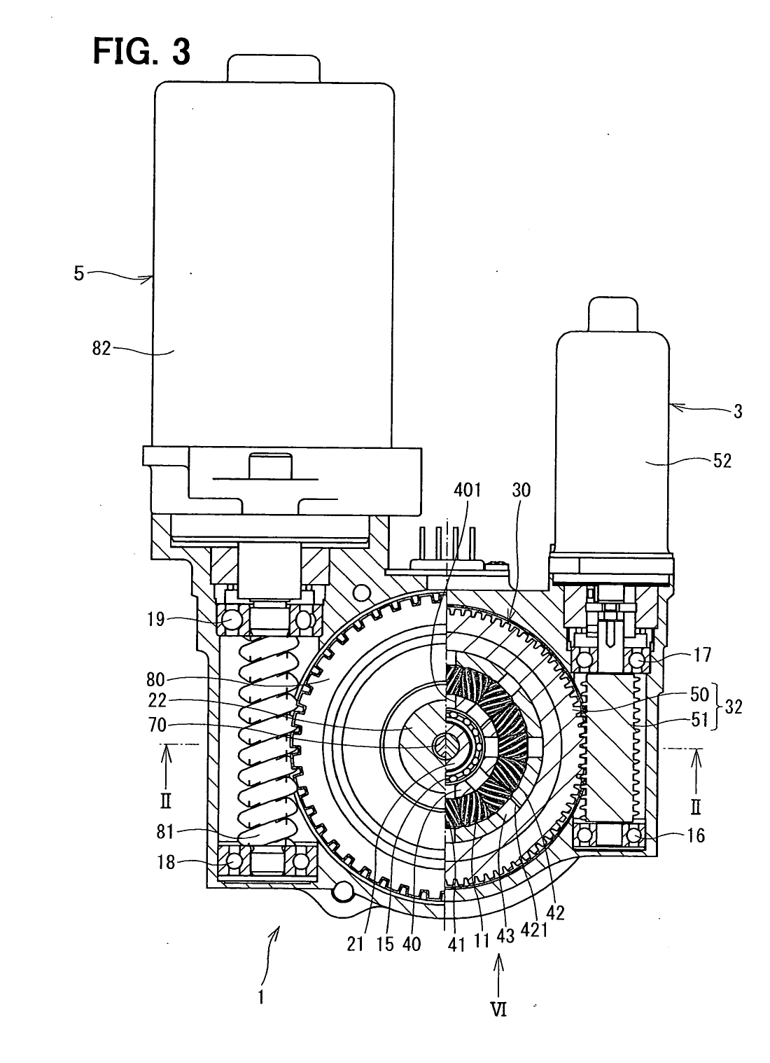

As described above and shown in FIG. 2 and FIG. 3, the steering control apparatus 1 includes the housing 12, the input shaft 10, the output shaft 20, the VGRS device 3, the EPS device 5 and the like. The housing 12 is formed of a housing body 121 and an end frame 122. The housing body 121 and the end frame 122 are fixed to each other by screws 123. A gear mechanism 30 is accommodated within the housing 12. The input shaft 10 and the output shaft 20 are passed through the housing 12. A first bearing device 13 is provided in the housing body 121 at a side, which is opposite to the end frame 122. A second bearing device 14 is provided in the end frame 122 to rotatably support a second output shaft 22, which will be described later.

The output shaft 20 is formed of a first output shaft 21 and a second output shaft 22. The first output shaft 21 and the second output shaft 22 are formed in a hollow pipe shape. A torsion bar 70 is passed through the inside of the hollow pipe. The first output shaft 21 is provided closer to the input shaft 10 than the second output shaft 22 is. The first output shaft 21 has an enlarged part 211 having a large inner diameter at a side opposite to the input shaft 10. The second output shaft 22 has a reduced part 221 at a side of the first output shaft 21. The reduced part 221 is smaller in outer diameter than an inner diameter of the enlarged part 211. The reduced part 221 of the second output shaft 22 is inserted into the enlarged part 211 of the first output shaft 21.

The torsion bar 70 is passed through a space formed in a radially inside part of the first output shaft 21 and the second output shaft 22. Serration 701 is formed on the torsion bar 70 at an axial end of the torsion bar 70 at a side of the input shaft 10. The serration 701 is tightly fit with serration formed on a radially inside face of the first output shaft 21. The end of the torsion bar 70, which is opposite to the input shaft 10, is coupled to the output shaft 22 by a pin 702. Thus, the first output shaft 21 and the second output shaft 22 are thus coupled to be relatively rotatable by the torsion bar 70. When torsion torque is applied to the torsion bar 70 because of relative rotation between the first output shaft 21 and the second output shaft 22, twist of predetermined resiliency generated about the shaft is generated. As a result, the torque applied between the first output shaft 21 and the second output shaft 22. Twist displacement of the torsion bar 70 is detected by a steering torque detection device 4.

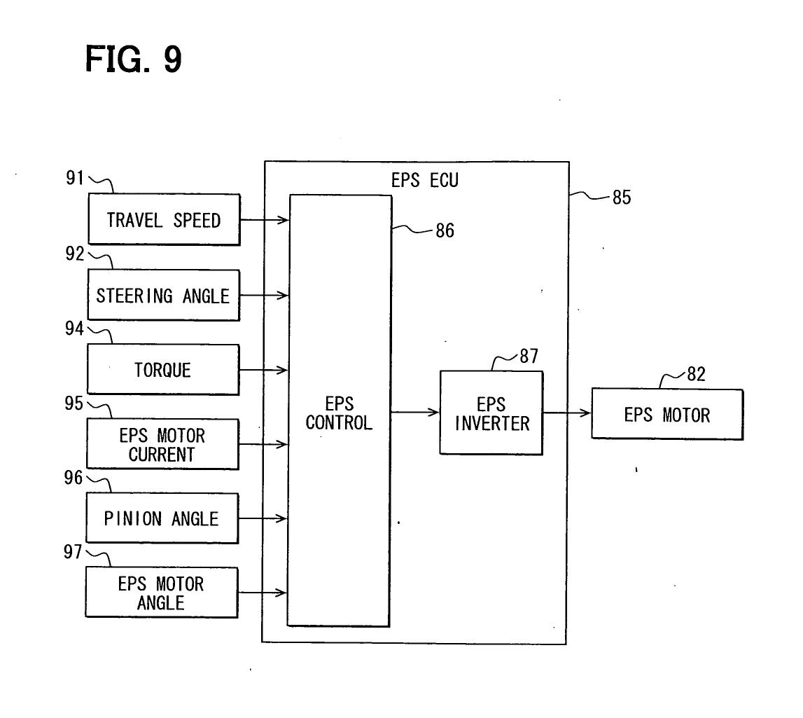

The steering torque detection device 4 detects steering torque, which is generated by operating the steering wheel 8, by detecting twist displacement of the torsion bar 70. The steering torque detection device 4 includes multiple-pole magnets 71, a set of steering torque magnetic yoke 72, 73, a set of magnetic flux collecting rings 75, 76 and a torque sensor 94 (shown in FIG. 1, FIG. 8 and FIG. 9, etc.). The steering torque detection device 4 is provided with a slight gap in the axial direction relative to an output gear 23, which will be described later.

The multiple-pole magnets 71 are formed in an annular ring shape and press-fitted with the first output shaft 21. Thus, the multiple-pole magnets 71 rotate with the first output shaft 21. The multiple-pole magnets 71 are positioned at a side more opposite to the input shaft 10 in the axial direction than an output gear 23 press-fitted with the first output shaft 21. The multiple-pole magnets 71 are magnetized with N-pole and S-pole alternately in the circumferential direction.

The set of magnetic yokes 72 and 73 are provided radially outside of the multiple-pole magnets 71 and in magnetic field formed by the multiple-pole magnets 71. The magnetic yokes 72 and 73 have nails, which extend in the axial direction from a set of annular ring parts facing in the axial direction, respectively. The nails of the yokes 72 and 73 are interleaved alternately by shifting in the circumferential direction. The magnetic yokes 72 and 73 are molded integrally with a resin mold 74. The resin mold 74 is press-fitted on the radially outside part of the second output shaft 22 through a collar, which is not shown. Thus, the magnetic yokes 72 and 73 rotate with the second output shaft 22.

The set of magnetic flux collecting rings 75 and 76 are formed in an annular shape and provided radially outside the resin mold 74, which molds the magnetic yokes 72 and 73, in a manner to be relatively rotatable against the resin mold 74. One magnetic flux collecting ring 75 is positioned to correspond to one yoke 72 in the axial direction. The other magnetic flux collecting ring 76 is positioned to correspond to the other magnetic yoke 73 in the axial direction. Although not shown, an air gap is provided between the magnetic flux collecting ring 75 and the magnetic flux collecting ring 76. The torque sensor 94 is positioned in the air gap to detect magnetic flux density in the air gap.

A method of detecting steering torque Tq by the torque sensor 94 will be described next. When no steering torque is applied to the output shaft 20, no twist displacement is generated in the torsion bar 70. In this instance, a center of each nail of the magnetic yokes 72 and 73 and a boundary line between the N-pole and the S-pole of the magnet 71 are in alignment. The same number of magnetic lines come in the nails of the magnetic yokes 72 and 73 from the N-pole of the magnet 71 and go out from the magnetic yokes 72 and 73 to the S-pole of the magnet 71. The magnetic lines inside the magnetic yoke 72 are closed, and the magnetic lines inside the magnetic yoke 73 are closed. No magnetic flux thus leaks in the air gap formed between the magnetic flux collecting rings 75 and 76. As a result, the magnetic density detected by the torque sensor 94 is zero.

When steering torque Tq is applied to the output shaft 20 on the other hand, twist displacement is generated in the torsion bar 70. In this instance, the relative position between the multiple-pole magnets 71 and the magnetic yoke 72 and 73 is changed in the circumferential direction. The center of each nail of the magnetic yokes 72 and 73 and the boundary line between the N-pole and the S-pole of the magnet 71 are not in alignment any more. Magnetic lines having polarities of the N-pole and the S-pole increase in the magnetic yokes 72 and 73, respectively. Magnetic flux thus leaks in the air gap formed between the magnetic flux collecting rings 75 and 76. As a result, the magnetic density detected by the torque sensor 94 is not zero any more. The magnetic density detected by the torque sensor 94 is generally proportional to the twist displacement amount of the torsion bar 70, and polarity of the detected magnetic density reverses in correspondence to the direction of twisting. Thus, the twist displacement of the torsion bar 70 is detected. As described above, the torque generated between the first output shaft 21 and the second output shaft 22 is converted into twist displacement of the torsion bar 70. The steering torque detection device 4 thus detects torque generated between the first output shaft 21 and the second output shaft 22 by detecting magnetic density generated in the air gap.

The VGRS device 3 includes the gear mechanism 30 and a VGRS motor 52, which is provided as a first motor for driving the gear mechanism 30. The gear mechanism 30 is formed of the differential gear 31 and the worm gear 32. The differential gear 31 includes an input gear 11, an output gear 23 and a pinion gear 41. The worm gear 32 includes a worm wheel 50 and a worm 51.

The input gear 11 is positioned at a side opposite to the steering wheel 8 of the input shaft 10. The input gear 11 is a bevel wheel, which is made of metal or resin and meshes the pinion gear 41. The input gear 11 includes a cylindrical tube part 111 and a gear part 112, which is formed in a bevel shape and positioned radially outside the tubular part 111. The input shaft 10 is press-inserted into the tubular part 111. The tubular part 111 is supported rotatably relative to the housing body 121 by the first bearing part 13 provided in the housing body 121. The input shaft 10 and the input gear 11 are thus supported rotatably in the housing 12. An axial end part of the first output shaft 21, which is at the side of the input shaft 10, is inserted in the radially inside part of the input gear 11. A needle bearing 113 is provided between the input gear 11 and the first output shaft 21. The first output shaft 21 is thus supported rotatably by the input gear 11. The second output shaft 22 is supported rotatably by the second bearing device 14.

The output gear 23 is provided to face the gear part 112 of the input gear 11 sandwiching the pinion gear 41. The output gear 23 is a bevel gear, which is made of metal or resin and meshes the pinion gear 41. The first output shaft 21 of the output shaft 20 is press-fitted into the output gear 23. The output gear 23 is provided at a position, which is more opposite to the input shaft 10 in the axial direction than the needle bearing 113 is.

A plurality of pinion gears 41 is provided between the input gear 11 and the output gear 23. The pinion gear 41 is a bevel wheel, which meshes the input gear 11 and the output gear 23. Here, relation among the input gear 11, the output gear 23 and the pinion gear 41 will be described. The number of teeth of the pinion gear 41 is even. The numbers of teeth of the input gear 11 and the output gear 23 are the same and odd. As a result, the point of contact between the teeth of the input gear 11 and the pinion gear 41 varies in correspondence to rotation. Similarly, the point of contact between the teeth of the output gear 23 and the pinion gear 41 varies in correspondence to rotation. For this reason, it is less likely that wear of a specified tooth progresses and local wear shortens durability. It is possible to change the number of teeth of the pinion gear to be odd so that the input gear 11 and the output gear 23 have the same number of teeth.

The input gear 11, the output gear 23 and the pinion gear 41 have spiral teeth so that rate of meshing between the input gear 11 and the pinion gear 41 and the rate of meshing between the output gear 23 and the pinion gear 41 are increased. Thus, operation sound generated by abutting of teeth can be reduced and ripple vibration transferred from the steering wheel 8 to a driver can be reduced. In case that the input gear 11 and the output gear 23 are made of metal, the pinion gear 41 is made of resin. In case that the input gear 11 and the output gear 23 are made of resin, the pinion gear 41 is made of metal. Thus, sound of hitting generated when gears mesh can be reduced.

The pinion gear 41 is positioned radially outside of the first output shaft 21 so that its rotation axis perpendicularly crosses the rotation axis of the input shaft 10 and the output shaft 20. The pinion gear 41 is formed an axial hole, through which a pinion gear shaft member 43 is passed. The axial hole formed in the pinion gear 41 is formed to have a diameter, which is slightly larger than an outer diameter of the pinion gear shaft member 43.

A third bearing 15 and an inner ring member 40 are provided between the pinion gear 41 and the first output shaft 21. The third bearing 15 is positioned between the needle bearing 113 and the output gear 23 in the axial direction and between the first output shaft 21 and the inner ring member 40 in the radial direction. The third bearing 15 thus rotatably supports the inner ring member 40 at a position radially outside the first output shaft 21.

The inner ring member 40 is formed first holes 401, which pass in a direction perpendicular to the rotation axis of the first output shaft 21. The first holes 401 are formed equi-angularly in the circumferential direction of the inner ring member 40. One axial end of the pinion gear shaft member 43, which is passed through the pinion gear 41, is press-fitted in the first hole 401.

An outer ring member 42 is provided radiallly outside the inner ring member 40 sandwiching the pinion gear 41. The outer ring member 42 is formed second holes 402, which pass in a direction perpendicular to the rotation axis of the first output shaft 21. The second holes 421 are formed equi-angularly in the circumferential direction of the outer ring member 42. The second holes 421 are formed at positions, which correspond to the first holes 401 of the inner ring member 40. The other axial end of the pinion gear shaft member 43, which is passed through the pinion gear 41, is press-fitted in the second hole 421. The other axial end of the pinion gear shaft member 43 is opposite to the axial end of the same fitted in the first hole 401. That is, the pinion gear 41 is positioned between the inner ring member 40 and the outer ring member 42 to be rotatable about an axis of the pinion gear shaft member 43, which is supported by the inner ring member 40 and the outer ring member 42. According to this configuration, the pinion gear shaft member 43 can be formed and assembled readily. The inner ring member 40, the outer ring member 42 and the pinion gear shaft member 43 form a supporting member.

The worm wheel 50 is made of resin or metal and press-fitted on the radially outside part of the outer ring member 42. That is, the first output shaft 21, the third bearing 15, the inner ring member 40, the pinion gear 41, the outer ring member 42 and the worm wheel 50 are arranged in this order from the radially inside part. The inner ring member 40, the outer ring member 42, the pinion gear shaft member 43 and the worm wheel 50 rotate together as a single body. The third bearing 15 rotatably supports the inner ring member 40, the outer ring member 42, the pinion gear shaft member 43 and the worm wheel 50 at a position radially outside the first output shaft 21.

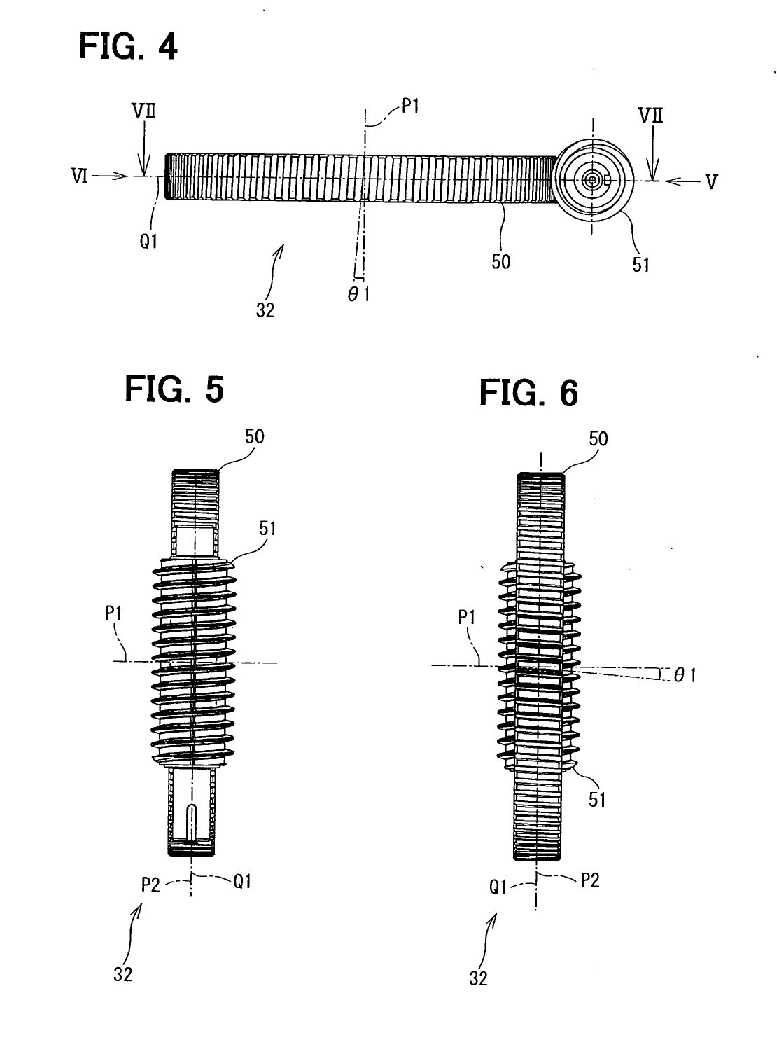

As shown in FIG. 3, the worm 51 meshes the radially outside part of the worm wheel 50. The worm 51 is supported rotatably by a fourth bearing 16 and a fifth bearing 17 provided in the housing 12. Here, the worm wheel 51 and the worm 50 are described with reference to FIG. 4 to FIG. 7.

The worm wheel 50 and the worm 51 are arranged such that a plane Q1 perpendicular to the rotation axis P1 of the worm wheel 50 and the rotation axis P2 of the worm 51 are parallel to each other. The tooth trace of the worm wheel 50 is formed to incline to the rotation axis P1 of the worm wheel 50 by an angle θ1. This angle of inclination corresponds to a lead angle. The lead angle θ1 is set to be smaller than a friction angle. As a result, the worm wheel 50 is rotated by the rotation of the worm 51. However, the worm 51 is not rotated by the rotation of the worm wheel 50. Thus, the worm wheel 50 and the worm 51 are capable of self-locking. The speed increase ratio is 1 when the worm wheel 50 and the worm 51 are self-locked.

The worm wheel 50 is formed such that its tooth bottom is distant from the rotation axis P1 by a constant distance. Thus, even if positions of the worm wheel 50 and the worm 51 deviate in the direction of rotation axis P1 because of manufacturing tolerance, for example, the worm wheel 50 and the worm 51 are maintained in abutting relation in both rotations in the normal direction and in the reverse direction.

Referring back to FIG. 2 and FIG. 3, the VGRS motor 52 is provided at a side of the fifth bearing 17 of the worm 51. The VGRS motor 52 is a brush motor. The VGRS motor 52 drives the worm 51 in forward and reverse directions in correspondence to energization (current supply). When the VGRS motor 52 drives the worm 51 in the forward direction and the worm wheel 50 correspondingly rotates in the same direction as the rotation direction of the input shaft 10, the rotation of the input shaft 10 is transferred to the output shaft 20 after being reduced in speed. When the VGRS motor 52 drives the worm 51 in the reverse direction and the worm wheel 50 correspondingly rotates in a direction opposite to the rotation direction of the input shaft 10, the rotation of the input shaft 10 is transferred to the output shaft 20 after being increased in speed. Thus, the rotation angle of the input shaft 10 and the rotation angle of the output shaft 20 are varied.

The EPS device 5 is provided at a position opposite to the VGRS motor 52 sandwiching the input shaft 10 and the output shaft 20. The EPS device 5 includes an EPS worm wheel 80, an EPS worm 81 and an EPS motor 82. The wheel 80 and the EPS worm 81 are accommodated within the housing 12.

The EPS worm wheel 80 is made of resin or metal. The EPS worm wheel 80 is press-fitted on the second output shaft 22 and rotates together with the second output shaft 22. The EPS worm 81 meshes the radially outside part of the wheel 80. The EPS worm 81 is supported rotatably by a sixth bearing 18 and a seventh bearing 19, which are provided in the housing 12. Teeth of the wheel 80 are so formed that each tooth line is parallel with the rotation shaft. A tooth bottom of the wheel 80 formed to be planer and not arcuate. Thus, even if the position of placing the wheel 80 deviates in the axial direction of the second output shaft 22 due to manufacturing error, contact between the wheel 80 and the EPS worm 81 can be maintained similarly in both cases of forward rotation and reverse rotation.

The EPS motor 82 is provided as a second motor at a side of a seventh bearing 19 of the EPS worm 81. The EPS motor 82 is a brushless three-phase motor. The EPS motor 82 drives the EPS worm 81 to rotate in forward and reverse directions depending on eneargization. When the wheel 80 meshed with the EPS worm 81 applies steering assist torque to the second output shaft 22, steering operation is assisted. The VGRS device 3 and the EPS device 5 are provided on both sides of the output shaft 20, the radial loads generated when the VGRS motor 52 and the EPS motor 82 are driven are cancelled out and inclination of the output shaft 20 is suppressed. Since the inclination of the output shaft 20 is suppressed, the position of meshing of the worm wheel 50 and the worm 51 and the position of meshing of the EPS worm wheel 80 and the EPS worm 81 are surely maintained.

A VGRS electronic control unit (VGRS ECU) for controlling drive of the VGRS motor 52 and an EPS electronic control unit (EPS ECU) for controlling drive of the EPS motor 82 will be described with reference to FIG. 8 and FIG. 9. FIG. 8 is a block diagram showing the VGRS ECU 55, and FIG. 9 is a block diagram showing the EPS ECU 85.

As shown in FIG. 8, the VGRS ECU 55 includes a VGRS control part (first control part) 56 and a VGRS inverter 57. The VGRS control part 56 is formed as an electronic computer circuit, which includes a CPU, a ROM, a RAM, an I/O and a bus line connecting these components, and performs drive control for the VGRS motor 52. The VGRS control part 56 is connected to a travel speed sensor 91 for detecting a travel speed of a vehicle, a steering wheel angle sensor 92 for detecting a steering wheel angle θh of the steering wheel 8, a VGRS motor rotation angle sensor 93 for detecting a rotation angle (VGRS motor rotation angle θvm) of the VGRS motor 52, the torque sensor 94 for detecting steering torque Tq generated when the steering wheel 8 is operated, a pinion angle sensor 96 for detecting a pinion angle θp, and the like. The torque sensor 94 may be a sensor, which is common with the EPS. The torque sensor value may be acquired from the EPS ECU 85 through communication such as CAN. The VGRS control part 56 controls the VGRS inverter 57 based on the travel speed, the steering wheel angle θh, the VGRS motor rotation angle θvm and the like.

The inverter is formed of a plurality of switching elements, which are connected in a bridge form, to switch over energization condition of the VGRA motor 52. The switching elements forming the VGRS inverter 57 are tuned on and off by the VGRS control part 56 based on the travel speed, the steering wheel angle θh and the VGRS motor rotation angle θvm. That is, the VGRS control part 56 controls driving of the VGRS motor 52 by controlling the VGRS inverter 57 in accordance with the travel speed, the steering wheel angle θh and the VGRS motor rotation angle θvm.

As shown in FIG. 9, the EPS ECU 85 includes an EPS control part 86 (second control part) and an EPS inverter 87. The EPS control part 86 is formed as an electronic computer circuit, which includes a CPU, a ROM, a RAM, an I/O and a bus line connecting these components, and performs drive control for the EPS motor 82. The EPS control part 86 is connected to the travel speed sensor 91, the torque sensor 94 for detecting steering torque Tq of the steering wheel 8, an EPS motor current sensor 95 for detecting motor current supplied to the EPS motor 82, the pinion angle sensor 96 and an EPS motor rotation angle sensor 97 (referred to EPS motor rotation angle θem), and the like.

The EPS inverter 87 is a three-phase inverter, which is formed of a plurality of switching elements in the bridge form, and switches over energization of the EPS motor 82. The switching elements forming the EPS inverter 87 are turned on and off by the EPS control part 86 based on the travel speed, the steering torque Tq, the motor current and the like. That is, the EPS control part 86 controls operation of the EPS motor 82 by controlling the EPS inverter 87.

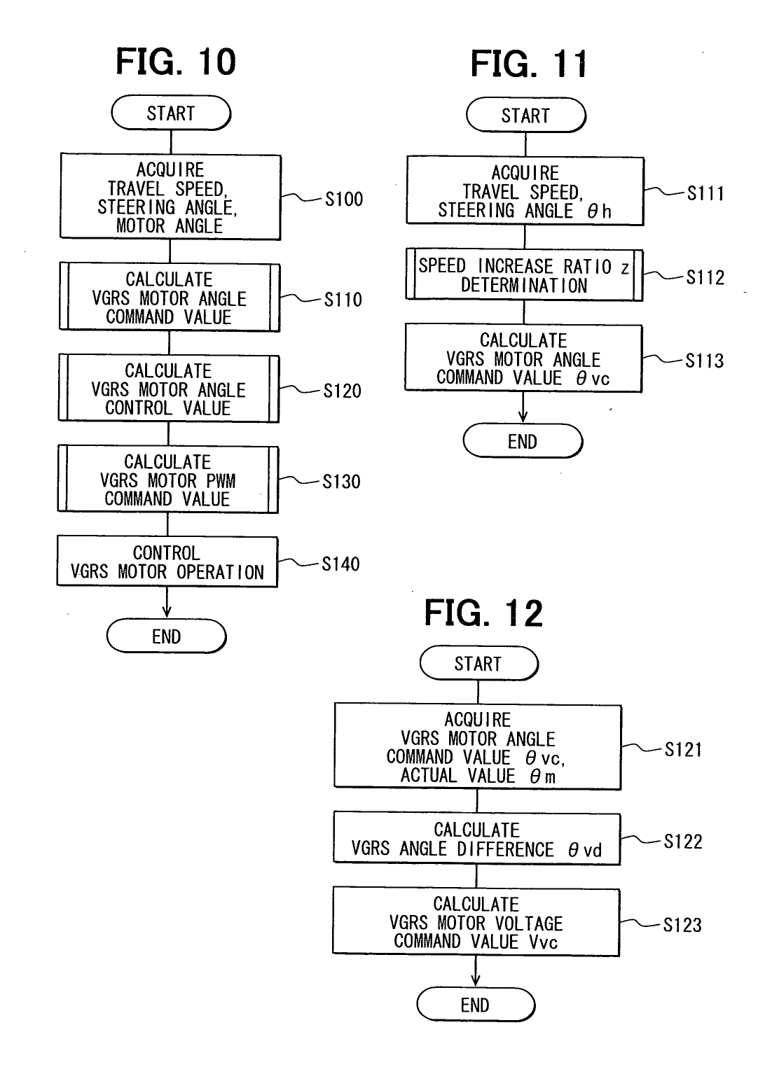

Control processing, which is executed by the VGRS control part 56 for the VGRS motor 52, will be described next with reference to FIG. 10 to FIG. 14. A main part of the control processing of the VGRS control part 56 for the drive control of the VGRS motor 52 is shown in FIG. 10.

First at S100 (S indicates a step), a travel speed sensor value outputted by the travel speed sensor 91 is retrieved and the travel speed of the vehicle is acquired. Further, a steering wheel angle sensor value outputted by the steering wheel angle sensor 92 is retrieved and the steering wheel angle of the steering wheel 8 is acquired. In addition, a VGRS motor rotation angle sensor value outputted by the VGRS motor rotation angle sensor 93 is retrieved and the VGRS motor rotation angle is acquired. At S110, VGRS motor rotation angle command value calculation processing is performed. At S120, VGRS motor rotation angle control calculation processing is performed. At S130, VGRS motor PWM command value calculation processing is performed. At S140, the operation of the VGRS motor 52 is controlled by switching over on/off of the switching elements forming the VGRS inverter 57 based on the PWM command value calculated at S130.

The VGRS motor rotation angle command value calculation processing of S110 will be described with reference to FIG. 11. At S111, the travel speed sensor value outputted by the travel speed sensor 91 is retrieved to acquire the travel speed of the vehicle. Further, the steering wheel angle sensor value outputted by the steering wheel angle sensor 92 is retrieved to acquire the steering wheel angle θh of the steering wheel 8. It is assumed that the steering wheel angle is positive and negative, when the steering wheel 8 is operated in the clockwise direction and the counter-clockwise direction, respectively. By the operation of the differential gear 31, the output shaft 20 rotates in the counter-clockwise direction when the steering wheel 8 and the input shaft 10 rotates in the clockwise direction. The output shaft 20 rotates in the clockwise direction when the steering wheel 8 and the input shaft 10 rotate in the counter-clockwise direction. For this reason, the pinion angle θp, which is the rotation angle of the output shaft 20, is assumed to be positive and negative in case of rotations in the counter-clockwise direction and the clockwise direction, respectively.

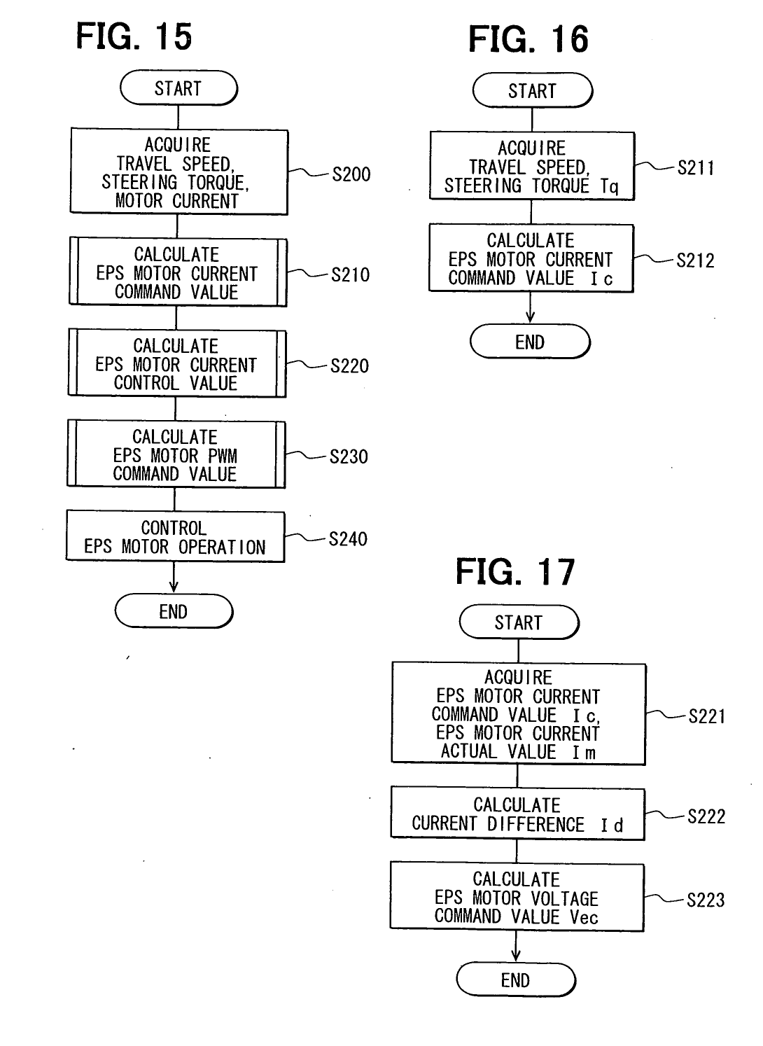

At S112, the speed increase ratio z is calculated based on the travel speed acquired at S111. The relation between the travel speed and the speed increase ratio z is stored as a function shown in FIG. 14. That is, as understood from FIG. 15, the speed increase ratio z increases with an increase in the travel speed when the travel speed is lower than a predetermined speed value. The speed increase ratio z however decreases with an increase in the travel speed when the travel speed is higher than the predetermined speed value. The speed increase ratio z is a ratio between the steering wheel angle θh and the pinion angle θp. Therefore, a set rotation angle of the output shaft 20 is calculated by multiplying the steering wheel angle. In case that the speed increase ratio z is 1, the steering wheel angle θh and the pinion angle θp agree. For example, when the input shaft 10 rotates by an angle θx in the clockwise direction when viewed from the steering wheel 8 under the speed increase ratio z is 1, the output shaft 20 rotates by the same angle θx in the counter-clockwise direction.

Referring to FIG. 11, at S113, a VGRS motor rotation angle command value θvc is calculated thus ending the processing. The VGRS motor rotation angle command value θvc is calculated by the following equation (1), assuming that θh is the steering wheel angle acquired at S111, z is the speed increase ratio calculated at S112 and iv is a reduction ratio of the worm gear 32.

θvc=θh×(z−1)×iv×0.5 (1)

The VGRS motor rotation angle control calculation processing of S120 will be described next with reference to FIG. 12. At S121, the VGRS motor rotation angle command value θvc calculated at S113 in FIG. 11 is retrieved. Further, a VGRS motor rotation angle sensor value outputted by the VGRS motor rotation angle sensor 93 is retrieved to acquire the VGRS motor rotation angle θvm. The VGRS motor rotation angle θvm may be represented by the pinion angle θ. At S122, an angle difference value θvd is calculated. The VGRS motor rotation angle difference value θvd is calculated by the following equation (2).

θvd=θvc−θvm (2)

At S123, a VGRS motor voltage command value Vvc is calculated, thereby ending this processing. The VGRS motor voltage command value Vvc is feedback-controlled by using PI control. Assuming that a proportional gain and an integral gain in the VGRS motor feedback-control are KPv and KIv, respectively, the VGRS motor voltage command value Vvc is calculated by the following equation (3).

Vvc=KPv×θvd+KIv×∫θvddt (3)

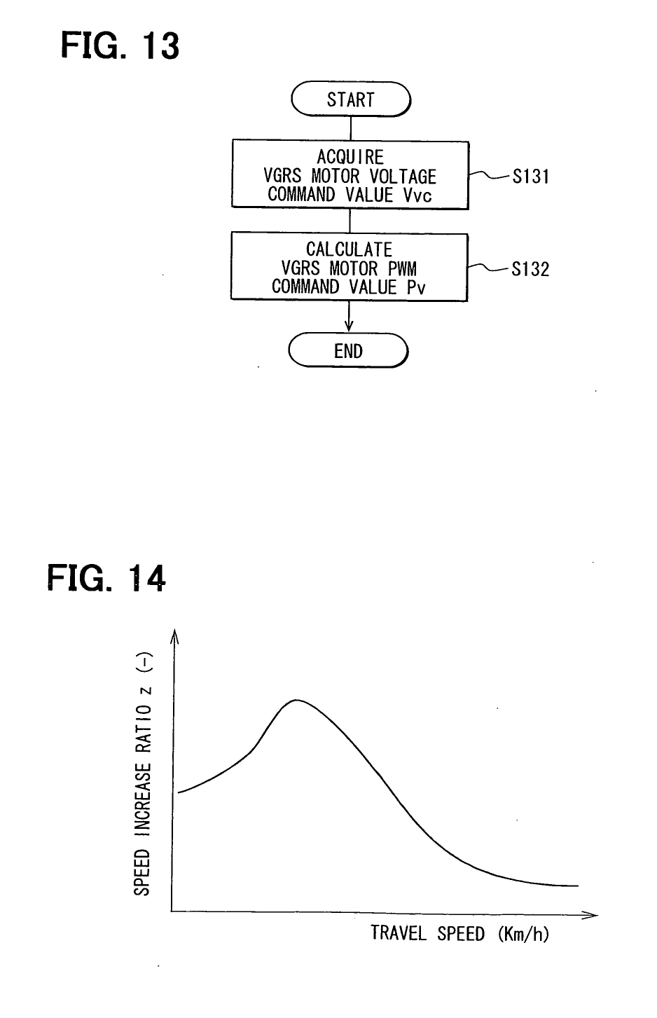

The PWM command value calculation processing of S130 will be described with reference to FIG. 13. At S131, the VGRS motor voltage command value Vvc calculated at S123 in FIG. 12 is acquired. At S132, a VGRS motor PWM command value Pv is calculated. Assuming that a battery voltage is Vb, the VGRS motor PWM command value Pv is calculated by the following equation (4).

Pv=Vvc/Vb×100 (4)

The VGRS control part 56 controls the operation of the VGRS motor 52 by controlling timing of on/off of the switching elements of the VGRS inverter 57 (S140 in FIG. 10) based on the VGRS motor PWM command value Pv calculated at S132. The ratio between the rotation angle of the steering wheel angle θh and the pinion angle θp is varied by driving the VGRS motor 52 based on the steering wheel angle θh and the speed increase ratio. Thus, the VGRS control part 56 makes the steered angle of the vehicle wheels 7 variable relative to the steering wheel angle θh by controlling driving of the VGRS motor 52.

Here, a case that the speed increase ratio is 1 is described. In case that the speed increase ratio is 1, the VGRS motor rotation angle command value θvc calculated by the equation (1) becomes 1. The worm gear 32 has a self-lock function and, hence, the worm 51 is not rotated by the rotation of the worm wheel 50. The VGRS motor 52 is not rotated either by the rotation of the worm wheel 50 through the worm 51. For this reason, if the VGRS motor rotation angle command value θvc is approximately 0, that is, if the speed increase ratio is 1, the VGRS motor rotation angle θvm becomes 0 when energization of the VGRS motor 52 is turned off. Thus, since energization of the VGRS motor 52 can be turned off when the speed increase ratio is 1, power consumption can be reduced.

Control processing for the EPS part 5 by the EPS control part 86 will be described next with reference to FIG. 15 to FIG. 18, assuming that the VGRS device 3 has no failure. A main part of the control processing of the part 86 for the EPS device 5 is shown in FIG. 15. First at S200, the travel speed sensor value outputted by the travel speed sensor 91 is retrieved and the travel speed of the vehicle is acquired. Further, a torque sensor value outputted by the torque sensor 94 is retrieved and the steering torque generated when the steering wheel 8 is operated by a driver is acquired. In addition, a current sensor value outputted by the EPS motor current sensor 95 is retrieved and the motor current supplied to the EPS motor 82 is acquired.

At S210, EPS motor current command value calculation processing is performed. At S220, EPS motor current control calculation processing is performed. At S230, a PWM command value calculation processing is performed. At S240, the operation of the EPS motor 82 is controlled by switching over on/off of the switching elements forming the EPS inverter 87 based on the PWM command value calculated at S230.

The EPS motor current command value calculation processing will be described with reference to FIG. 16. At S211, the travel speed sensor value outputted by the travel speed sensor 91 is retrieved to acquire the travel speed of the vehicle. Further, the torque sensor value outputted by the torque sensor 94 is retrieved to acquire the steering torque Tq generated when the steering wheel 8 is operated by the driver.

At S212, the EPS motor rotation current command value Ic is calculated based on the travel speed and the steering torque Tq acquired at S211, thereby ending this processing. The relation between the steering torque Tq and the EPS motor current command value Ic at each travel speed is pre-stored in a memory as a data map. The relation between the steering torque Tq and the EPS motor current command value Ic is pre-stored for each travel speed as a data map as shown in FIG. 19. As shown in FIG. 19, the EPS motor current command value Ic increases as the steering torque Tq increases. The EPS motor current command value Ic is decreases as the travel speed increases under a condition that the steering torque Tq is the same.

The EPS motor current command control calculation processing will be described next with reference to FIG. 17. At S221, the EPS motor current command value Ic calculated at S212 in FIG. 16 is retrieved. Further, the current sensor value outputted by the EPS motor current sensor 95 is retrieved to acquire the EPS motor current Im supplied to the EPS motor 82. At S222, a current difference value Id is calculated. The current difference value Id is calculated by the following equation (5).

Id=Ic−Im (5)

At S223, an EPS motor voltage command value Vec is calculated, thereby ending this processing. The EPS motor voltage command value Vec is feedback-controlled by using PI control. Assuming that a proportional gain and an integral gain in the EPS motor feedback-control are KPe and KIe, respectively, the VGRS motor voltage command value Vec is calculated by the following equation (6).

Vec=KPe×Id+KIe×∫Iddt (6)

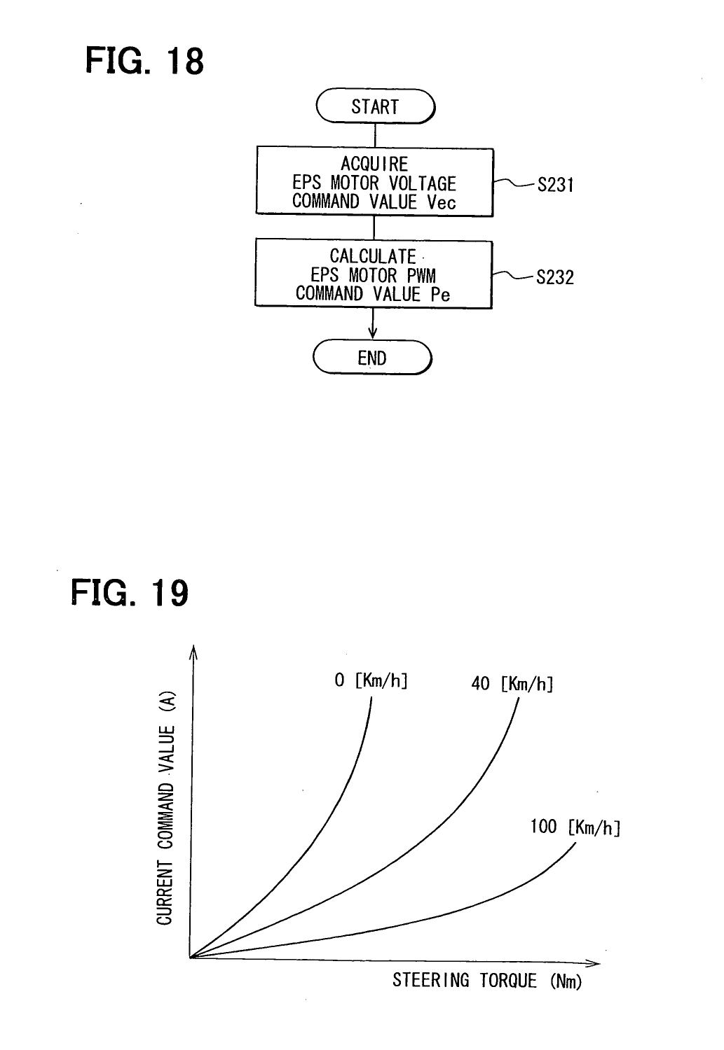

The EPS motor PWM command value calculation processing will be described with reference to FIG. 18. At S231, the EPS motor voltage command value Vec calculated at S223 in FIG. 17 is acquired. At S232, an EPS motor PWM command value Pe is calculated. Assuming that the battery voltage is Vb, the EPS motor PWM command value is calculated by the following equation (7).

Pe=Vec/Vb×100 (7)

The EPS control part 86 controls the operation of the EPS motor 82 (S240 in FIG. 15) by controlling timing of on/off of the switching elements of the EPS inverter 87 based on the EPS motor PWM command value Pe calculated by the foregoing equation (7).

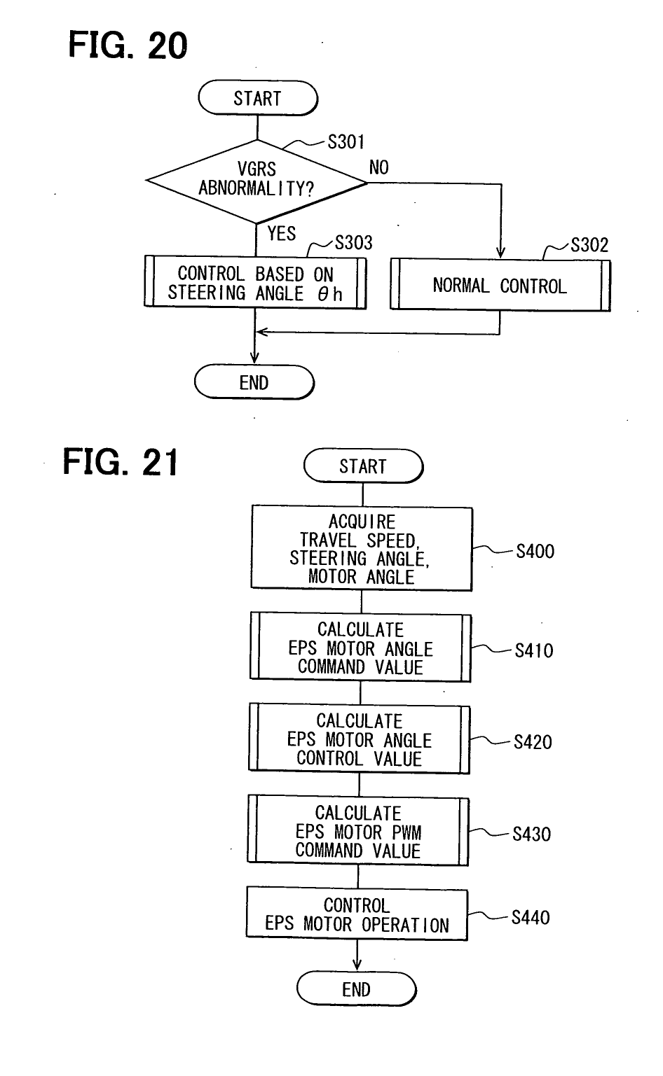

According to the first embodiment, the EPS device 5 performs the variable gear ratio control, which varies the steered angle of the vehicle wheels 7 relative to the steering wheel angle θh, when abnormality arises in the VGRS device 3. VGRS device abnormality check processing by the EPS control part 86 will be described with reference to FIG. 20 to FIG. 24.

The VGRS device abnormality check processing will be described with reference to the flowchart shown in FIG. 20. This processing is executed at every predetermined interval during travel of the vehicle.

At S301, it is checked whether the VGRS device 3 has abnormality. One example of abnormality in the VGRS device 3 is self-lock failure in the worm gear. This self-lock failure may be detected as described later. The VGRS device abnormality may further include, in addition to the self-lock failure of the worm gear 32, a wire-break in the VGRS device 3, short-circuit of the VGRS inverter 57 to the power source or the ground and failure in any of the switching elements. Each of the failure may be detected in the conventional manner. If it is determined that the VGRS device 3 has any abnormality (S301:YES), S303 is executed. If it is determined that the VGRS device 3 has no abnormality (S301:NO), 5302 is executed.

At S302, normal control is performed. Specifically, as described with reference to FIG. 15 to FIG. 18, driving of the EPS motor 82 is controlled based on the steering torque Tq.

At S303, which is executed if the VGRS device 3 has abnormality (S301:YES), the EPS motor 82 is controlled based on the steering wheel angle θh. That is, control is switched from torque-based control, which is performed based on the steering torque Tq, to angle-based control, which is performed based on the steering wheel angle θh. It is noted that driving of the VGRS motor 52 is not controlled by the VGRS control part 56 at this time, so that drive of the VGRS motor 52 is stopped.

Here, the control processing for the EPS motor 82, which is executed at S303 when the VGRS device 3 has abnormality, will be described with reference to FIG. 21 to FIG. 24. A main part of the VGRS device abnormality control processing is shown in FIG. 21.

First at S400, the travel speed sensor value outputted by the travel speed sensor 91 is retrieved and the travel speed of the vehicle is acquired. Further, the steering wheel angle sensor value outputted by the steering wheel angle sensor 92 is retrieved and the steering wheel angle of the steering wheel 8 is acquired. In addition, the EPS motor rotation angle sensor value outputted by the EPS motor rotation angle sensor 97 is retrieved and the EPS motor rotation angle is acquired. At S410, EPS motor rotation angle command value calculation processing is performed. At S420, EPS motor rotation angle control calculation processing is performed. At S430, EPS motor PWM command value calculation processing is performed. At S440, the operation of the EPS motor 82 is controlled by switching over on/off of the switching elements forming the EPS inverter 87 based on the PWM command value calculated at S430.

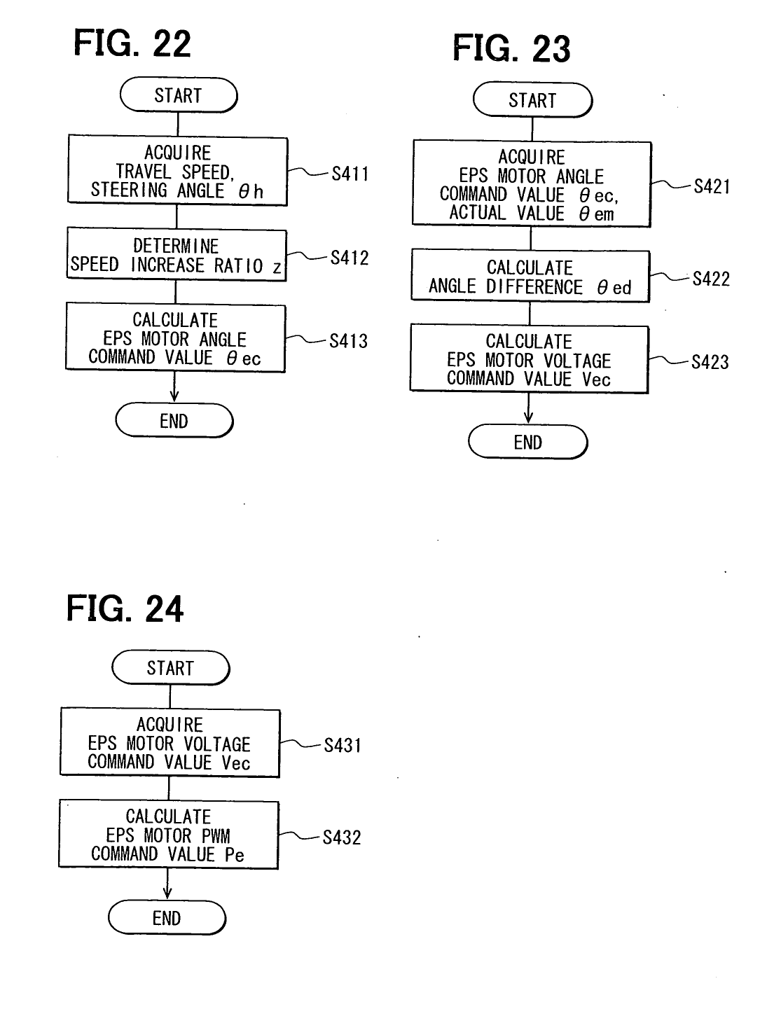

The EPS motor rotation angle command value calculation processing of S410 will be described with reference to FIG. 22. At S411, the travel speed sensor value outputted by the travel speed sensor 91 is retrieved to acquire the travel speed of the vehicle. Further, the steering wheel angle sensor value outputted by the steering wheel angle sensor 92 is retrieved to acquire the steering wheel angle θh of the steering wheel 8.

At S412, the speed increase ratio z is acquired based on the travel speed acquired at S411. The relation between the travel speed and the speed increase ratio z is stored as a function shown in FIG. 14. At S413, an EPS motor rotation angle command value θec is calculated thus ending the processing. The EPS motor rotation angle command value θec is calculated by the following equation (8), assuming that θh is the steering wheel angle acquired at S411, z is the speed increase ratio calculated at S412 and ie is a reduction ratio between the worm wheel 80 and the EPS worm 81.

θec=θh×(z−1)×ie×0.5 (8)

The EPS motor rotation angle control calculation processing of S420 will be described next with reference to FIG. 23. At S421, the EPS motor rotation angle command value θec calculated at S413 in FIG. 22 is retrieved. Further, the EPS motor rotation angle sensor value outputted by the EPS motor rotation angle sensor 97 is retrieved to acquire the EPS motor rotation angle θem. The EPS motor rotation angle θem may be represented by the pinion angle θp. At S422, an angle difference value Bed is calculated. The EPS motor rotation angle difference value Bed is calculated by the following equation (9).

θed=θec−θem (9)

At S423, the EPS motor voltage command value Vec is calculated, thereby ending this processing. The EPS motor voltage command value Vec is feedback-controlled by using PI control. Assuming that a proportional gain and an integral gain in the EPS motor feedback-control are KPe2 and KIe2, respectively, the EPS motor voltage command value Vec is calculated by the following equation (10).

Vec=KPe2×θed+KIe2×∫θeddt (10)

The PWM command value calculation processing of S430 will be described with reference to FIG. 24. At S431, the EPS motor voltage command value Vec calculated at S423 in FIG. 23 is acquired. At S432, the EPS motor PWM command value Pe is calculated. Assuming that the battery voltage is Vb, the EPS motor PWM command value Pe is calculated by the equation similar to the foregoing equation (7).

The EPS control part 86 controls the operation of the EPS motor 82 by controlling timing of on/off of the switching elements of the EPS inverter 87 (S440 in FIG. 21) based on the EPS motor PWM command value Pe calculated at S432. As a result, it is not possible that a driver will sense the steering operation even when he/she operates the steering wheel 8. However, since the steered angle of the vehicle wheels 7 relative to the steering wheel angle Oh is not changed between before and after occurrence of abnormality in the VGRS device 3, a driver will not have a sense of discomfort.

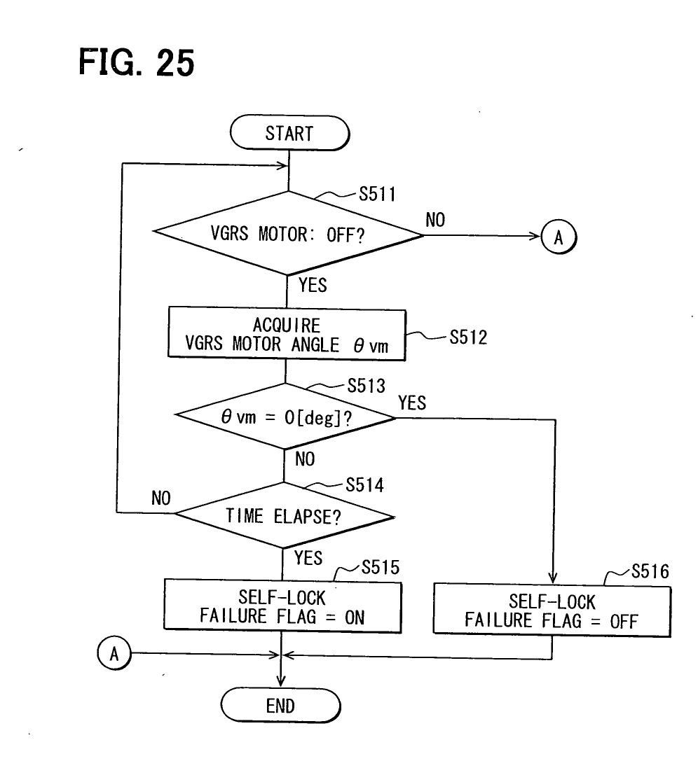

The self-lock failure detection processing (1) to (5) for detecting the self-lock failure of the worm gear 32 in the worm gear 32 of the VGRS device 3 will be described with reference to FIG. 25 to FIG. 29. Only one of the self-lock failure detection processing (1) to (5) may be executed or a plurality of the same may be executed in parallel. The self-lock failure detection processing is executed by the VGRS control part 56 at every predetermined interval during travel of the vehicle.

### <Self-Lock Failure Detection Processing (1)>

The self-lock failure detection processing (1) detects the self-lock failure based on that the voltage command value for the VGRS motor 52 becomes 0 and the rotation angle of the VGRS motor 52 becomes 0, when the speed increase ratio is 1 and the self-lock operation is normal. The self-lock failure detection processing (1) will be described with reference to FIG. 25.

At S511, it is checked whether the VGRS motor 52 is turned off (energization:OFF). It is possible to check it by checking whether an absolute value of an energization voltage to the VGRS motor 52 is less than a predetermined value, because it may be influenced by noises. If it is determined that the VGRS motor 52 is not turned off (S511:NO), S512 to S516 are not executed. If it is determined that energization of the VGRS motor 52 is turned off (S511:YES), S512 is executed.

At S512, the VGRS motor rotation angle sensor value outputted by the VGRS motor rotation angle sensor 93 is retrieved and the VGRS motor rotation angle θvm is acquired. At S513, it is checked whether the acquired VGRS motor rotation angle θvm is approximately 0. If it is determined that the VGRS motor rotation angle θvm is approximately 0 (S513: YES), S516 is executed. If it is determined that the VGRS motor rotation angle θvm is not approximately 0 (S513:NO), S514 is executed.

At S514, it is checked whether a predetermined time has elapsed. If it is determined that the predetermined time has not yet elapsed (S514:NO), S511 to S514 are executed again. If it is determined that the predetermined time has elapsed (S514:YES), 5515 is executed. At S515, the self-lock failure flag is turned on (set to ON), because the worm gear 32 has abnormality in its self-lock function.

At S516, which is executed if the VGRS motor 52 is turned off (S511:YES) and the VGRS motor rotation angle is approximately 0 (S513:YES), the self-lock function of the worm gear 32 is normal and hence the self-lock failure flag is turned off (set to OFF). It is possible to immediately execute S515 without S514, if the determination result at S513 is NO.

### <Self-Lock Failure Detection Processing (2)>

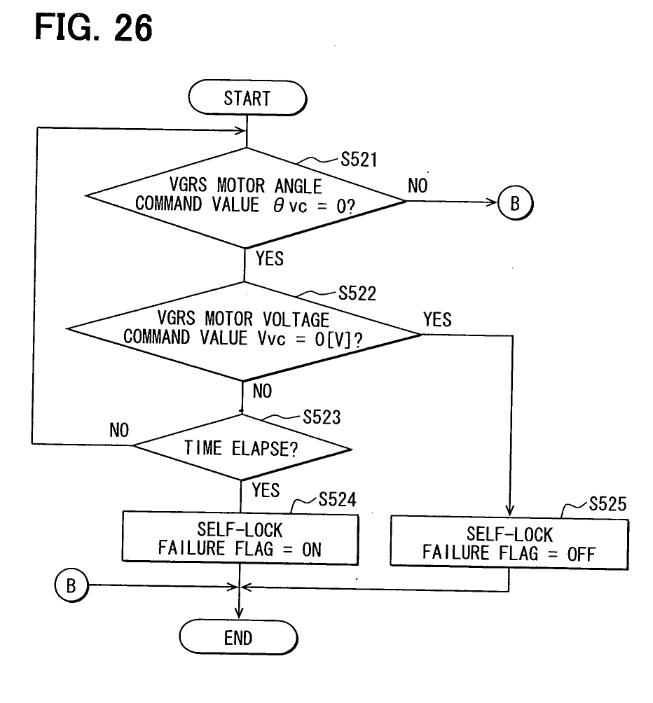

Self-lock failure detection processing (2) detects the self-lock failure based on that the rotation angle command value θvc for the VGRS motor 52 becomes 0 and the voltage command value Vvc for the VGRS motor 52 becomes 0, when the speed increase ratio is 1 and the self-lock operation is normal. The self-lock failure detection processing (2) will be described with reference to FIG. 26.

At S521, it is checked whether the VGRS motor rotation angle command value θvc is approximately 0. The VGRS motor rotation angle command value θvc is calculated in the similar manner as S113 in FIG. 11. If it is determined that the VGRS motor rotation angle command value θvc is not 0 (S521:NO), S522 to S525 are not executed. If it is determined that the VGRS motor rotation angle command value θvc is approximately 0 (S521:YES), S522 is executed.

At S522, it is checked whether the VGRS motor voltage command value Vvc is approximately 0. The VGRS motor voltage command value Vvc is calculated in the similar manner as S123 in FIG. 12. If it is determined that the VGRS motor voltage command value Vvc is approximately 0 (S522: YES), S525 is executed. If it is determined that the VGRS motor voltage command value Vvc is not 0 (S522:NO), S523 is executed.

At S523, it is checked whether a predetermined time has elapsed. If it is determined that the predetermined time has not yet elapsed (S523:NO), S521 to S523 are executed again. If it is determined that the predetermined time has elapsed (S523:YES), 5524 is executed. At S524, the self-lock failure flag is turned on (set to ON), because the worm gear 32 has abnormality in its self-lock function.

At S525, which is executed if the VGRS motor rotation angle command value θvc is approximately 0 (S521:YES) and the VGRS motor voltage command value Vvc is approximately 0 (S522:YES), the self-lock function of the worm gear 32 is normal and hence the self-lock failure flag is turned off (set to OFF). It is possible to immediately execute S524 without execution of S523, if the determination result at S522 is NO.

### <Self-Lock Failure Detection Processing (3)>

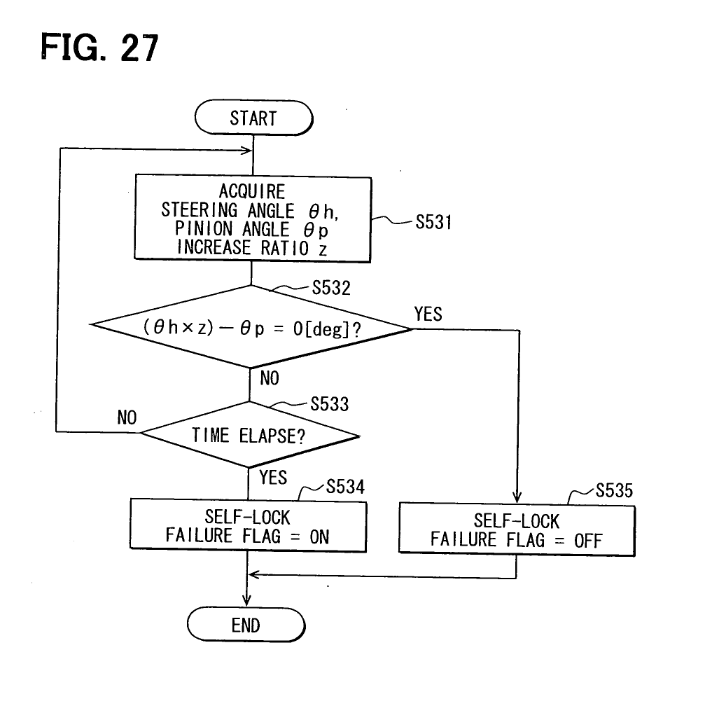

Self-lock failure detection processing (3) detects the self-lock failure based on that a set rotation angle equals the pinion angle θp, when the self-lock operation is normal. The set rotation angle is a product of the steering wheel angle θh and the speed increase ratio z. The self-lock failure detection processing (3) will be described with reference to FIG. 27.

At S531, the steering wheel angle θh is acquired by retrieving the output value of the steering wheel angle sensor 92, which detects the steering wheel angle. The pinion angle θp is acquired by retrieving the output value of the pinion angle sensor 96, which detects the pinion angle. Further, the speed increase ratio z is acquired based on the travel speed. The pinion angle θp may be estimated based on the VGRS motor rotation angle θvm. At S532, the set rotation angle is calculated by multiplying the acquired steering wheel angle θh by the speed increase ratio z. Then it is checked whether a difference, which results from subtraction of the pinion angle θp from the calculated set rotation angle, is approximately 0. If it is determined that the difference between the pinion angle θp and the set rotation angle is approximately 0 (S532:YES), that is, the set rotation angle equals the pinion angle θp, S535 is executed. If it is determined that the difference between the pinion angle θp and the set rotation angle is not 0 (S532:NO), that is, the set rotation angle does not equal the pinion angle θp, S533 is executed.

At S533, it is checked whether a predetermined time has elapsed. If it is determined that the predetermined time has not yet elapsed (S533:NO), S531 to S533 are executed again. If it is determined that the predetermined time has elapsed (S533:YES), S534 is executed. At S534, the self-lock failure flag is turned on (set to ON), because the worm gear 32 has abnormality in its self-lock function.

At S535, which is executed if the difference between the set rotation angle and the pinion angle θp is approximately 0 (S532:YES), the self-lock function of the worm gear 32 is normal and hence the self-lock failure flag is turned off (set to OFF). It is possible to immediately execute S534 without execution of S533, if the determination result at S532 is NO.

### <Self-Lock Failure Detection Processing (4)>

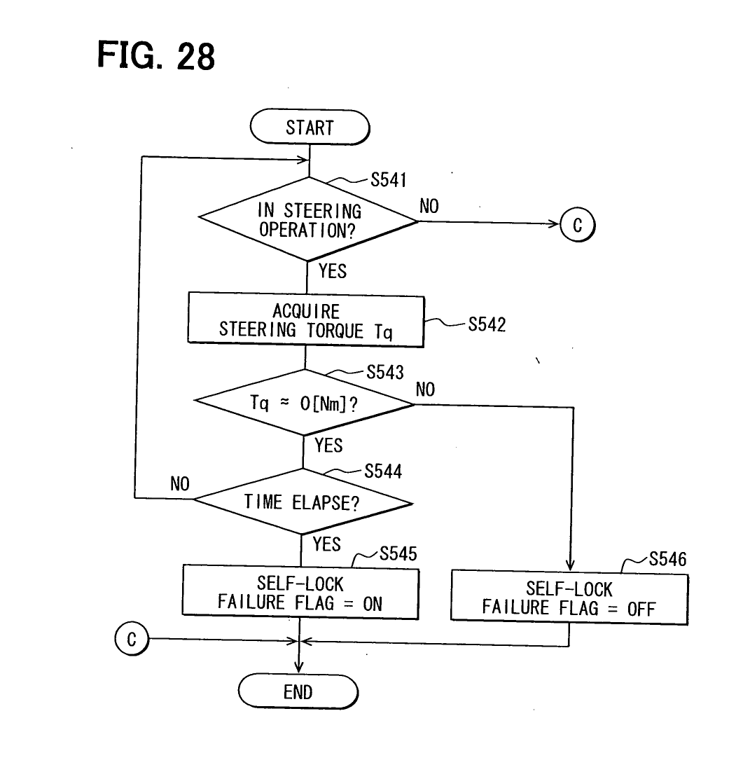

If the self-lock function of the worm gear 32 is normal, torque is transferred to the output shaft 20 side and detected as the steering torque by the torque sensor 94 when the steering wheel 8 is operated. If the steering wheel 8 idles because of self-lock failure, torque is not transferred to the output shaft 20 side and is not detected by the torque sensor 94. Self-lock failure is detected in self-lock failure detection processing based on the steering torque. The self-lock failure detection processing (4) will be described with reference to FIG. 28.

At S541, it is checked whether the steering wheel 8 is being rotated as steering operation. If it is determined that the steering wheel 8 is not in the steering operation (S541:NO), S542 to 5546 are not executed. If it is determined that the steering wheel 8 is in the steering operation (S541:YES), 5542 is executed. At S542, the torque sensor value outputted by the torque sensor 94 is retrieved and the steering torque Tq generated by the steering operation of the steering wheel 8 is acquired.

At S543, it is checked whether the acquired steering torque Tq is approximately 0. If it is determined that the steering torque Tq is not approximately 0 (S543: NO), 5546 is executed. If it is determined that the steering torque Tq is approximately 0 (S543:YES), S544 is executed. At S544, it is checked whether a predetermined time has elapsed. If it is determined that the predetermined time has not yet elapsed (S544:NO), S541 to S544 are executed again. If it is determined that the predetermined time has elapsed (S544:YES), 5545 is executed. At S545, the self-lock failure flag is turned on (set to ON), because the worm gear 32 has abnormality in its self-lock function.

At S546, which is executed if the steering wheel 8 is in the steering operation (S541:YES) and the steering torque Tq is not approximately 0 (S543:NO), the self-lock function of the worm gear 32 is normal and hence the self-lock failure flag is turned off (set to OFF). It is possible to immediately execute 5545 without executing S544, if the determination result at S543 is YES.

### <Self-Lock Failure Detection Processing (5)>

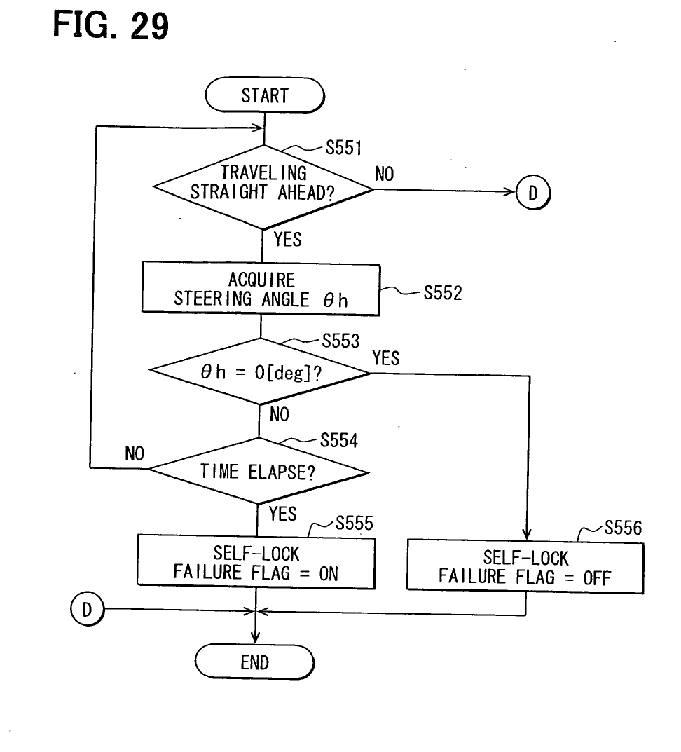

If the self-lock function of the worm gear 32 is normal, the steering wheel 8 does not idle. As a result, the steering wheel angle θh becomes 0 when the vehicle travels straight. If the steering wheel 8 idles because of self-lock failure, the steering wheel 9 is likely to idle. In this case, the steering wheel angle θh deviates from 0 even when the vehicle travels straight. Self-lock failure is detected in self-lock failure detection processing (5) based on the steering wheel angle θh. The self-lock failure detection processing (5) will be described with reference to FIG. 29.

At S551, it is checked whether the vehicle is traveling straight ahead. Whether the vehicle is traveling straight may be checked in the conventional manner. For example, it is determined that the vehicle is traveling straight if differences in wheel rotation speeds among four vehicle wheels are small. As another example, it is determined that the vehicle is traveling straight if a yaw rate sensor or an acceleration sensor detects no yaw or no lateral acceleration. If it is determined that the vehicle is not traveling straight (S551:NO), S552 to S556 are not executed. If it is determined that the vehicle is traveling straight (S551:YES), S552 is executed. At S552, the steering wheel angle sensor value outputted by the steering wheel angle sensor 92 is retrieved and the steering wheel angle θh is acquired.

At S553, it is checked whether the steering wheel angle θh is approximately 0. If it is determined that the steering wheel angle θh is approximately 0 (S553: YES), S556 is executed. If it is determined that the steering wheel angle θh is not approximately 0 (S553:NO), S554 is executed. At S554, it is checked whether a predetermined time has elapsed. If it is determined that the predetermined time has not yet elapsed (S554:NO), S551 to S554 are executed again. If it is determined that the predetermined time has elapsed (S554:YES), S555 is executed. At S555, the self-lock failure flag is turned on (set to ON), because the worm gear 32 has abnormality in its self-lock function.

At S556, which is executed if the vehicle is traveling straight (S551:YES) and the steering wheel angle θh is approximately 0 (S553:YES), the self-lock function of the worm gear 32 is normal and hence the self-lock failure flag is turned off (set to OFF). It is possible to immediately execute S555 without executing S554, if the determination result at S553 is YES.

It is to be noted that, although elapse of the predetermined time is checked at S514 in FIG. 25, S523 in FIG. 26, S533 in FIG. 27, S544 in FIG. 28 and S554 in FIG. 29, the predetermined time may be set arbitrarily. The predetermined times may be the same or different among the processing (1) to (5). It is also to be noted that, in checking whether the values are approximately 0 in the self-lock detection processing (1) to (5), it may be determined that the values are 0 if absolute values of the same are equal to or smaller than the predetermined values. Thus, influence of noise can be eliminated. According to the first embodiment, if the self-lock failure flag is set, the flag indicates occurrence of failure in the self-lock operation in the worm gear 32. As a result, the check result at S301 in FIG. 20 becomes YES and S303 is executed.

In a conventional lock mechanism, a lock pin is driven by a solenoid or the like, for example. It is therefore easy to detect abnormality of the lock mechanism by monitoring the solenoid. As the lock mechanism in the first embodiment, the worm gear 32 is formed to have the self-lock configuration. Although it is not possible to detect abnormality in the worm gear 32 by monitoring a solenoid or the like, it is possible to appropriately detect the self-lock failure in the worm gear 32 by executing at least one of the self-lock failure detection processing (1) to (5).

As described above, in the steering control apparatus 1, the input shaft 10 is coupled to the steering wheel 8, which is steered by a driver. The output shaft 20 is provided relatively rotatably to the input shaft 10 and forms a torque transfer path for transferring torque applied to the steering wheel 8 to the vehicles wheels 7. The VGRS device 3 includes the gear mechanism 30, which transfers rotation of the input shaft 10 to the output shaft 20, and the VGRS motor 52, which drives the worm 51 of the gear mechanism 30. The VGRS device 3 varies the ratio between the steering wheel angle θh of the steering wheel 8 and the pinion angle θp, which is the rotation angle of the output shaft 20. The EPS device 5 includes the EPS motor 82 for power-assisting driver's steering operation of the steering wheel 8 by torque generated by driving the EPS motor 82.

The VGRS control part 56 acquires the steering wheel angle θh (S111 in FIG. 11) and determines the speed increase ratio z, which indicates the ratio between the steering wheel angle θh and the pinion angle θp (S112). The VGRS control part 56 controls drive of the VGRS motor 52 based on the steering wheel angle θh and the speed increase ratio z (S140 in FIG. 10). Thus, the pinion angle θp and the steered angle of the vehicle wheels 7 are variable relative to the steering wheel angle θh. The EPS control part 86 checks whether the VGRS device 3 has abnormality (S301 in FIG. 20). When it is determined that the abnormality is present (S301:YES), the drive of the EPS motor 82 is controlled based on the steering wheel angle θh and the speed increase ratio z (S303). Thus, the steered angle of the vehicle wheels 7 relative to the steering wheel angle θh agrees to that of a case of no abnormality in the VGRS device 3. That is, according to the first embodiment, the EPS motor 82 is controlled based on the steering wheel angle θh and the speed increase ratio z when abnormality arises in the VGRS device 3. The EPS device 5 performs the variable gear ratio control, by which the steered angle of the vehicle wheels 7 relative to the steering angle θh is varied. Thus, the steered angle of the vehicle wheels 7 can be appropriately controlled at time of abnormality in the VGRS device 3. Further, even when abnormality arises in the VGRS device 3, the steered angle of the vehicle wheels 7 relative to the steering angle θh does not change between before and after the occurrence of abnormality. Movement of a vehicle (yaw rate, vehicle travel trajectory or the like) relative to the steering wheel angle θh does not change either. Thus feeling of discomfort in vehicle steering operation can be reduced.

According to the first embodiment, the relation between the travel speed and the control method shown in FIG. 14 is not changed so that increase of program and expensive microcomputer, which will be required if the control method is changed between before and after occurrence of abnormality in the VGRS device 3, will not be needed. However, it is possible to change the relation between the travel speed and the speed increase ratio shown in FIG. 14 between before and after occurrence of abnormality in the VGRS device 3 so that a driver may sense occurrence of abnormality. It is also possible to change the steered angle of the vehicle wheels 7 relative to the steering wheel angle θh between before and after occurrence of abnormality in the VGRS device 3. For example, the speed increase, ratio z relative to the travel speed may be decreased to 70% of that shown in FIG. 14 uniformly over the entire travel speed range. In this case, the EPS actuator is not heavily loaded. Further, since movement of a vehicle will be slowed down even when the steering wheel 8 is operated quickly, it is avoided that a driver will drive the vehicle in the similar manner as in the normal time.

The gear mechanism 30 has the worm 51, which is driven by the VGRS motor 52, and the worm wheel 50, which meshes the worm 51. The lead angle θ1 is provided for a self-lock operation in the gear mechanism 30 so that the worm wheel 50 is rotatable by rotation of the worm 51 but the worm 51 is not rotatable by rotation of the worm wheel 50. It is thus not necessary to provide a lock mechanism, which locks the steered angle of the vehicle wheels 7 relative to the steering wheel angle θh, separately from the gear mechanism 30. The size of the apparatus can be reduced.

In case that the self-lock failure arises in the worm gear 32, no torque is transferred to the output shaft 20 and the steering wheel 8 will idle. It is therefore determined that the VGRS device 3 has abnormality (S301:YES, FIG. 20) when the gear mechanism 30 has the self-lock failure, which disables the self-lock operation. When the self-lock failure is present in the worm gear 32, driving of the EPS motor 82 is controlled based on the steering wheel angle θh and the speed increase ratio z. As a result, the steering wheel 8 is suppressed from idling at the time of self-lock failure and safety is enhanced.

The torque transfer path includes the column shaft 2, which includes the input shaft 10 and the output shaft 20, and the rack-and-pinion mechanism 6, which changes the rotary motion of the column shaft 2 to the linear motion. The VGRS device 3 and the EPS device 5 are mounted on the column shaft 2. Further, the VGRS device 3 and the EPS device 5 are integrated into a single module. Thus, the apparatus 1 can be reduced in its entire size and can be mounted even in compact-sized vehicles, which have less mounting space and are not suitable for mounting such apparatuses.

In the first embodiment, it is possible to control both the VGRS inverter 57 and the EPS inverter 87 by a single control part (not shown) in place of separately providing the VGRS control part 56 and the EPS control part 86. In this case, the single control part executes the processing shown in FIG. 10 to FIG. 29 to control both VGRS inverter 57 and EPS inverter 87 thereby controlling driving of both VGRS motor 52 and EPS motor 82.

### Second Embodiment

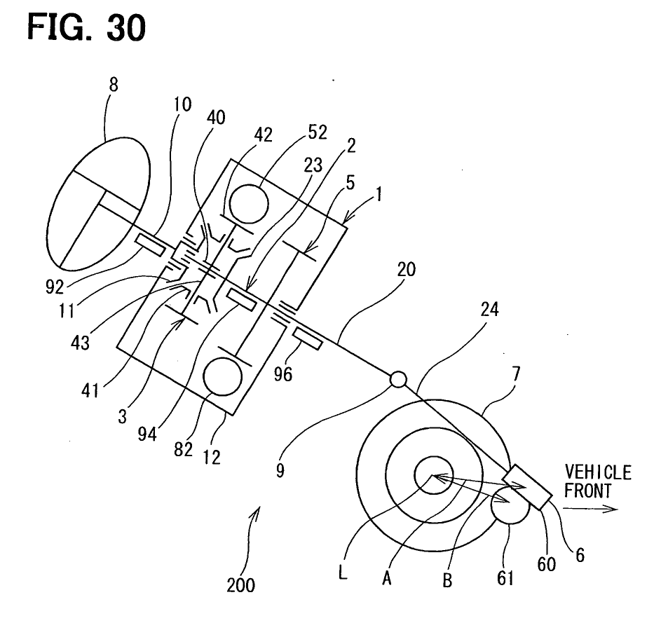

In the steering control apparatus according to the first embodiment, the rack-and-pinion mechanism 6 is provided at a more rear side of the vehicle from the straight line L, which is on the centers of rotation of the left and right vehicle wheels 7. The steering control apparatus may be modified as shown in FIG. 30 as a second embodiment.

As shown in FIG. 30, a steering system 200 may be configured to have the rack-and-pinion mechanism 6 at a more front side of the vehicle than the straight line L, which is on the centers of rotation of the left and right vehicle wheels 7. The distance A between the steering pinion 60 and the straight line L connecting the centers of rotation of the right and left vehicle wheels 7 is set to be longer than the distance B between the steering rack bar 61 and the straight line L connecting the centers of rotation of the right and left vehicle wheels 7.

The output shaft 20 rotates in the direction opposite from that of the input shaft 10 by the operation of the differential gear provided between the input shaft 10 and the output shaft 20. When the steering wheel 8 is turned in the counter-clockwise direction, the steering pinion 60 rotates in the clockwise direction and the steering rack bar 61 moves in the left direction when viewed from the universal joint 9 side. As a result, the steered angle of the steered tire wheels 7 is changed so that the vehicle turns in the left direction. When the steering wheel 8 is turned in the clockwise direction, the steering pinion 60 rotates in the counter-clockwise direction and the steering rack bar 61 moves in the right direction when viewed from the universal joint 9 side. As a result, the steered angle of the steered tire wheels 7 is changed so that the vehicle turns in the right direction.

Thus, by setting the distances A and B to satisfy A>B, that is, the distance A between the steering pinion 60 and the straight line L connecting the centers of rotation of the vehicle wheels 7 is longer than the distance B between the steering rack bar 61 and the straight line L, the vehicle wheels 7 are steered in the direction opposite from the direction of rotation of the output shaft 20, the shaft 24 and the steering pinion 60. Thus, the direction of rotation of the steering wheel 8 and the direction of the vehicle wheels 7 are matched.

### Third Embodiment

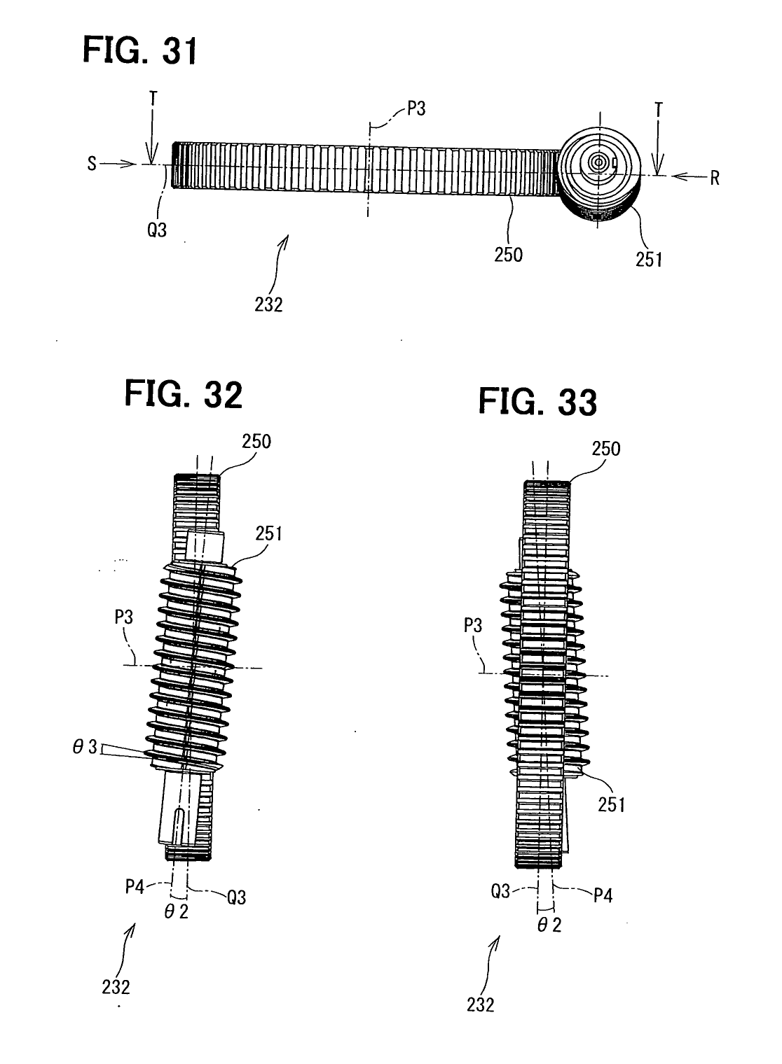

According to the first embodiment, the worm wheel 50 is configured to have the tooth trace, which is inclined relative to the axis of rotation of the worm wheel 50. However, it is possible that the worm wheel is configured to have a tooth trace, which is not inclined relative to the axis of rotation of the worm wheel, as exemplarily shown in FIG. 31 to FIG. 34 as a third embodiment.

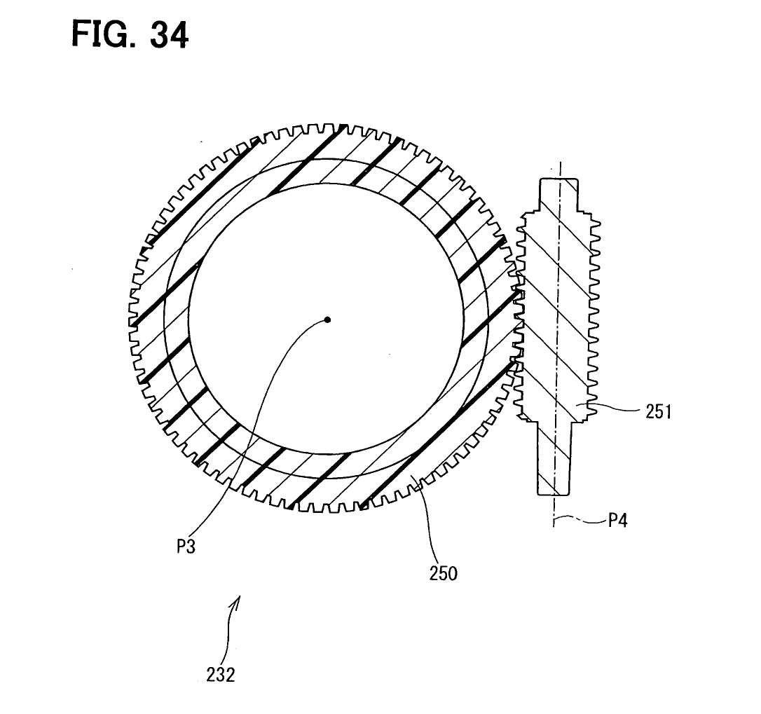

FIG. 31 shows a worm gear 232 in correspondence to FIG. 4. FIG. 32 shows the worm gear 232 viewed in a direction R in FIG. 31. FIG. 33 shows the worm gear 232 viewed in a direction S in FIG. 33. FIG. 34 shows the worm gear 232 in section taken along a line TT in FIG. 31. In this example, a worm wheel 250 and a worm 251 of the worm gear 232 are arranged such that a plane Q3 perpendicular to a rotation axis P3 of the worm wheel 250 and a rotation axis P4 of the worm 251 are inclined to form an inclination angle θ2. This inclination angle θ2 is substantially the same as a lead angle θ3 of the worm 251. By setting the lead angle θ3 to an angle, which enables self-locking operation, the same advantages are provided as in the first embodiment.

In this example, the tooth traces of the worm wheel 250 are formed to be in parallel to the rotation axis P3 of the worm wheel 250. As a result, contact surfaces between the teeth of the worm wheel 250 and the teeth of the worm 251 are parallel to the rotation axis P3 of the worm wheel 250. Thus, when motive power is transferred from the worm 251 to the worm wheel 250, the worm wheel 250 is protected from generation of thrust load and position of engagement between the worm 251 and the worm wheel 250 is maintained surely.

In case that the worm wheel 250 is formed of resin, a drawing die is formed cylindrically and cutting blades are provided on a radially inside part of the drawing die. The drawing die is moved in the direction of rotation axis P3, thereby readily forming the worm wheel 250. Thus, blade-cutting process for separately forming the teeth of the worm wheel 250 is eliminated and manufacturing cost is reduced.

### Other Embodiments

According to the first embodiment, the VGRS device 3 and the EPS device 5 are integrated into a single module and mounted on the column shaft 2. Alternatively, the VGRS device 3 and the EPS device 5 may be separated without being integrated. Further, the VGRS device 3 and the EPS device 5 may be provided at different locations, for example, on the column shaft 2 and the rack shaft (steering rack bar), respectively. In case that the EPS device 5 is mounted on the rack shaft, the amount of movement of the rack shaft is calculated based on the steering wheel angle θh and the increase ratio z when the VGRS device 3 has abnormality so that the steered angle of the vehicle wheels 7 relative to the steering wheel angle θh at the time of abnormality in the VGRS device 5 agrees to the steered angle of the vehicle wheels 7 relative to the steering wheel angle θh at the time of normal operation. The EPS motor 82 is controlled to attain the calculated amount of movement.

In the first embodiment, the lead angle is provided in the worm gear 32 for the self-lock operation. However, it is possible that the worm gear 32 is not provided with the self-lock function and a lock mechanism formed, of, for example, a lock pin and a latch member is provided separately from the gear mechanism. It is also possible to fix the steering ratio by torque of the VGRS motor 52. In case that the lock mechanism is provided, it is possible to determine that the VGRS device 3 has abnormality when abnormality arises in the lock mechanism due to, for example, breakage of the lock pin. Further, even in case that the VGRS device has abnormality, it is possible to continue the steering ratio varying processing by the VGRS device if the VGRS device is capable of continuing its steering ratio varying processing.

In this case, it is possible to determine that the variable gear ratio part has abnormality when the VGRS device is not capable of continuing the steering ratio varying processing.

The present invention is not limited to the foregoing embodiments and modifications, but may be implemented in other different embodiments.

What is claimed is:

1. A steering control apparatus comprising:
an input shaft coupled to a steering device operated by a driver of a vehicle;
an output shaft provided rotatably to the input shaft and forming a torque transfer path to transfer torque applied to the steering device to vehicle wheels;
a variable gear ratio device including a gear mechanism, which transfers rotation of the input shaft to the output shaft, and a first motor, which drives the gear mechanism, the variable gear ratio device varying a ratio between a steering wheel angle of the steering device and a rotation angle of the output shaft;
a power steering device including a second motor for power-assisting driver's steering operation of the steering device by torque generated by driving the second motor;
a steering wheel angle acquisition part for acquiring the steering wheel angle of the steering device;
a speed increase ratio determination part for determining a speed increase ratio, which indicates a ratio between the steering wheel angle of the steering device and the rotation angle of the output shaft;
a first drive control part for controlling drive of the first motor based on the steering wheel angle acquired by the steering wheel angle acquisition part and the speed increase ratio determined by the speed increase ratio determination part;
an abnormality check part for checking whether the variable gear ratio device has abnormality; and
a second control part for controlling the drive of the second motor based on the steering wheel angle and the speed increase ratio, when the abnormality check part determines that the variable gear ratio part has abnormality.

2. The steering control apparatus according to claim 1, wherein:
the gear mechanism has a worm, which is driven by the first motor, and a worm wheel, which meshes the worm; and
the gear mechanism has a lead angle for a self-lock operation, by which the worm wheel is rotated by rotation of the worm and the worm is not rotated by rotation of the worm wheel.

3. The steering control apparatus according to claim 2, wherein:
the abnormality check means determines that the variable gear ratio has abnormality when the gear mechanism has self-lock failure, which disables the self-lock operation of the gear mechanism.

4. The steering control apparatus according to claim 1, wherein:
the torque transfer path includes a column shaft, which includes the input shaft and the output shaft, and a rack-and-pinion mechanism, which changes rotary motion of the column shaft to linear motion; and
the variable gear ratio device and the power steering device are mounted on the column shaft.

5. The steering control apparatus according to claim 1, wherein:
the variable gear ratio device and the power steering device are integrated into a single module.

6. The steering control apparatus according to claim 1, wherein:
the second control part controls the second motor irrespective of the steering wheel angle and the speed increase ratio, when the abnormality check part determines that the variable gear ratio part has no abnormality.

7. The steering control apparatus according to claim 1, wherein:
the second control part controls the second motor based on steering torque applied to the steering device by the driver, when the abnormality check part determines that the variable gear ratio part has no abnormality.
